(19) United States
(12) Patent Application Publication
(10) Pub. No.: US 2026/0223047 A1
(43) Pub. Date: Jul. 30, 2026

(54) POSITIONING METHOD AND DEVICE IN WIRELESS COMMUNICATION SYSTEM

(71) Applicant: Samsung Electronics Co., Ltd., Suwon-si, Gyeonggi-do (KR)

(72) Inventors: Cheolkyu SHIN, Suwon-si (KR); Hyunseok RYU, Suwon-si (KR); Kyoungmin PARK, Suwon-si (KR); Kyunggyu LEE, Suwon-si (KR)

(21) Appl. No.: 19/146,163

(22) PCT Filed: Jan. 3, 2024
(86) PCT No.: PCT/KR2024/000070

§ 371 Date: Jul. 7, 2025

(30) Foreign Application Priority Data
Jan. 5, 2023 (KR) 10-2023-0001907
Jan. 10, 2023 (KR) 10-2023-0003584

(51) Int. Cl. H04W 64/00; H04L 5/00; H04W 24/08

(52) U.S. Cl. CPC H04W 64/00; H04L 5/0048; H04W 24/08

(57) ABSTRACT

The present disclosure relates to a method and a device, and the method performed by a terminal in a wireless communication system comprises the steps of receiving assistance data from a position server by using a positioning protocol defined between the terminal and the position server; receiving a downlink (DL) positioning reference signal (PRS) from a base station via a repeater; receiving a request for a position of the terminal from the position server; acquiring a measurement value related to the position of the terminal on the basis of the DL PRS; and transmitting the measurement value or position information of the terminal to the position server, wherein the position information is based on the assistance data and the measurement value, and the assistance data includes configuration information of the DL PRS, repeater timing error group (TEG) information for a delay occurring inside a repeater, base station TEG information for a delay occurring inside the base station, and propagation delay information on a delay occurring between the base station and the repeater.

### TECHNICAL FIELD

The disclosure relates to a wireless communication system and, particularly, to a method and a device for performing positioning (location measurement) when a repeater is used.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure relates to a wireless communication system and, in particular, provides a method and a device for performing positioning (location measurement) when a repeater is used.

### Solution to Problem

A method performed by a terminal in a wireless communication system of the disclosure may include: receiving assistance data from a location server by using a positioning protocol defined between the terminal and the location server; receiving a downlink (DL) positioning reference signal (PRS) from a base station via a repeater; receiving a request for a location of the terminal from the location server; based on the DL PRS, acquiring a measurement value related to the location of the terminal; and transmitting the measurement value or location information of the terminal to the location server, the location information being based on the assistance data and the measurement value, wherein the assistance data includes configuration information of the DL PRS, repeater timing error group (TEG) information for a delay occurring inside the repeater, base station TEG information for a delay occurring inside the base station, and propagation delay information on a delay occurring between the base station and the repeater.

A method performed by a location server in a wireless communication system of the disclosure may include: receiving, from a base station by using a positioning protocol annex defined between the base station and the location server, location information of a repeater, repeater TEG information for a delay occurring inside the repeater, repeater identification information, propagation delay information for a delay occurring while a downlink (DL) positioning reference signal (PRS) is being transmitted between the base station and the repeater, and base station TEG information for a delay occurring inside the base station while the DL PRS is being transmitted; transmitting assistance data including configuration information of the DL PRS, the repeater TEG information, the base station TEG information, and the propagation delay information to a terminal by using a positioning protocol defined between the terminal and the location server; transmitting a request for a location of the terminal to the terminal by using the positioning protocol; and receiving, from the terminal by using the positioning protocol, a measurement value based on the DL PRS and related to the location of the terminal, or location information of the terminal based on the assistance data and the measurement value.

A method performed by a repeater in a wireless communication system according to an embodiment of the disclosure may include: transmitting, to a base station, control information including location information of the repeater, identification information of the repeater, repeater TEG information for a delay occurring inside the repeater, and propagation delay information for a delay occurring while a downlink (DL) positioning reference signal (PRS) is being transmitted between the base station and the repeater; receiving the DL PRS and assistance data from the base station; and transmitting the DL PRS and the assistance data to a terminal. The assistance data may include configuration information of the DL PRS, the repeater TEG information, base station TEG information for a delay occurring inside the base station, and the propagation delay information for a delay occurring while the DL PRS is being transmitted between the base station and the repeater. Location information of the terminal may be based on the DL PRS and the assistance data.

A method performed by a repeater in a wireless communication system according to an embodiment of the disclosure may include: transmitting, to a location server, location information of the repeater and repeater TEG information for a delay occurring inside the repeater; receiving a downlink (DL) positioning reference signal (PRS) and assistance data from the base station; and transmitting the DL PRS and the assistance data to a terminal. The assistance data may include configuration information of the DL PRS, the repeater TEG information, base station TEG information for a delay occurring inside the base station, and propagation delay information for a delay occurring while the DL PRS is being transmitted between the base station and the repeater. Location information of the terminal may be based on the DL PRS and the assistance data.

A method performed by a first terminal in a wireless communication system according to an embodiment of the disclosure may include: receiving assistance data from a location server by using a sidelink positioning protocol defined between the first terminal and a second terminal; receiving a sidelink (SL) positioning reference signal (PRS) from the second terminal via a repeater; receiving a request for a location of the first terminal from the location server; based on the SL PRS, acquiring a measurement value related to the location of the first terminal; and transmitting the measurement value or location information of the first terminal to the location server, the location information being based on the assistance data and the measurement value, wherein the assistance data includes configuration information of the SL PRS, repeater timing error group (TEG) information for a delay occurring inside the repeater, second terminal TEG information for a delay occurring inside the second terminal, and propagation delay information on a delay occurring between the second terminal and the repeater.

A method performed by a repeater in a wireless communication system according to an embodiment of the disclosure may include: exchanging, with a first terminal, control information including location information of the repeater, identification information of the repeater, and repeater TEG information for a delay occurring inside the repeater; receiving a sidelink (SL) positioning reference signal (PRS) and assistance data from the first terminal; and transmitting the SL PRS and the assistance data to the second terminal. The assistance data may include configuration information of the SL PRS, the repeater TEG information, and first terminal TEG information for a delay occurring inside the first terminal. Location information of the second terminal may be based on the SL PRS and the assistance data.

A method performed by a repeater in a wireless communication system according to an embodiment of the disclosure may include: transmitting, to a location server, location information of the repeater and repeater TEG information for a delay occurring inside the repeater; receiving a sidelink (SL) positioning reference signal (PRS) and assistance data from the first terminal; and transmitting the SL PRS and the assistance data to the second terminal. The assistance data may include configuration information of the SL PRS, the repeater TEG information, and first terminal TEG information for a delay occurring inside the first terminal. Location information of the second terminal may be based on the SL PRS and the assistance data.

A method performed by a repeater in a wireless communication system according to an embodiment of the disclosure may include: transmitting first control information to a base station, wherein the first control information includes location information of the repeater, identification information of the repeater, repeater TEG information for a delay occurring inside the repeater, and propagation delay information for a delay occurring while a downlink (DL) positioning reference signal (PRS) is being transmitted between the base station and the repeater; receiving, from the base station, second control information including information related to a transmission occasion at which the DL PRS is transmitted by the base station; receiving the DL PRS and assistance data from the base station, wherein the assistance data includes configuration information of the DL PRS and base station TEG information for a delay occurring inside the base station; and based on the transmission occasion at which the DL PRS is transmitted by the base station, transmitting the assistance data among the assistance data and the DL PRS to a terminal. Location information of the terminal may be based on the assistance data.

A method performed by a repeater in a wireless communication system according to an embodiment of the disclosure may include: transmitting control information to a base station, wherein the control information includes location information of the repeater, identification information of the repeater, repeater TEG information for a delay occurring inside the repeater, and propagation delay information for a delay occurring while a downlink (DL) positioning reference signal (PRS) is being transmitted between the base station and the repeater; and receiving the DL PRS and assistance data from the base station, wherein the assistance data includes configuration information of the DL PRS and base station TEG information for a delay occurring inside the base station, and the configuration information of the DL PRS includes information related to a transmission occasion at which the DL PRS is transmitted by the base station. The method may include, based on the transmission occasion at which the DL PRS is transmitted by the base station, transmitting the assistance data among the assistance data and the DL PRS to a terminal. Location information of the terminal may be based on the assistance data.

A method performed by a repeater in a wireless communication system according to an embodiment of the disclosure may include transmitting first control information to a first terminal, wherein the first control information includes location information of the repeater, identification information of the repeater, repeater TEG information for a delay occurring inside the repeater, and propagation delay information for a delay occurring while a sidelink (SL) positioning reference signal (PRS) is being transmitted between the first terminal and the repeater. The method may further include: receiving, from the first terminal, second control information including information related to a transmission occasion at which the SL PRS is transmitted by the first terminal; and receiving the SL PRS and assistance data from the first terminal, wherein the assistance data includes configuration information of the SL PRS and first terminal TEG information for a delay occurring inside the first terminal. The method may further include, based on the transmission occasion at which the SL PRS is transmitted by the first terminal, transmitting the assistance data among the assistance data and the SL PRS to a second terminal. Location information of the second terminal may be based on the assistance data.

A method performed by a repeater in a wireless communication system according to an embodiment of the disclosure may include transmitting control information to a first terminal, wherein the control information includes location information of the repeater, identification information of the repeater, repeater TEG information for a delay occurring inside the repeater, and propagation delay information for a delay occurring while a sidelink (SL) positioning reference signal (PRS) is being transmitted between the first terminal and the repeater. The method may further include receiving the SL PRS and assistance data from the first terminal, wherein the assistance data includes configuration information of the SL PRS and first terminal TEG information for a delay occurring inside the first terminal, and the configuration information of the SL PRS includes information related to a transmission occasion at which the SL PRS is transmitted by the first terminal. The method may include, based on the transmission occasion at which the SL PRS is transmitted by the base station, transmitting the assistance data among the assistance data and the SL PRS to a second terminal. Location information of the second terminal may be based on the assistance data.

### Advantageous Effects of Invention

According to the disclosure, a method and a procedure for performing positioning (location measurement) in an environment where a repeater is used are provided.

### BRIEF DESCRIPTION OF DRAWINGS

FIG. TA illustrates a wireless communication system according to an embodiment of the disclosure.

FIG. 1B illustrates a wireless communication system according to an embodiment of the disclosure.

FIG. 1C illustrates a wireless communication system according to an embodiment of the disclosure.

FIG. 2 is a diagram illustrating a network-controlled repeater (NCR) according to an embodiment of the disclosure.

FIG. 3 is a diagram illustrating a positioning procedure in a Uu interface according to an embodiment of the disclosure.

FIG. 4 is a diagram illustrating a positioning procedure in a sidelink (SL) according to an embodiment of the disclosure.

FIG. 5 is a diagram for describing a timing error and a timing error group (TEG) when a repeater is not considered, according to an embodiment of the disclosure.

FIG. 6 is a diagram for describing a timing error and a TEG when a repeater is considered, according to an embodiment of the disclosure.

FIG. 7 is a diagram illustrating a positioning procedure considering a repeater in a Uu interface according to an embodiment of the disclosure.

FIG. 8 is a diagram illustrating a positioning procedure considering a repeater in an SL according to an embodiment of the disclosure.

FIG. 9 is a block diagram illustrating an internal structure of a UE according to an embodiment of the disclosure.

FIG. 10 is a block diagram illustrating an internal structure of a base station according to an embodiment of the disclosure.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

To meet the demand for wireless data traffic having increased since deployment of 4G communication systems, efforts have been made to develop an improved 5G communication system (new radio (NR)). The 5G communication system has been designed to support ultrahigh frequency (mmWave) bands (e.g., 28 GHz frequency bands) so as to accomplish higher data rates. To decrease propagation loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems. In the 5G communication system supports, unlike LTE, various subcarrier spacings such as 30 kHz, 60 kHz, and 120 kHz, as well as 15 kHz, are supported, and a physical control channel uses polar coding and a physical data channel uses a low density parity check (LDPC). In addition, CP-OFDM, as well as DFT-S-OFDM, is also used as a waveform for uplink transmission. While hybrid ARQ (HARQ) retransmission in units of transport blocks (TBs) are supported in LTE, HARQ retransmission based on a code block group (CBG) including a bundle of a plurality of code blocks (CBs) may be additionally supported in 5G.

In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (CoMPs), reception-end interference cancellation, and the like.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched. Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply the 5G communication system to IoT networks. For example, technologies such as a sensor network, machine type communication (MTC), and machine-to-machine (M2M) communication are implemented by beamforming, MIMO, and array antenna techniques that are 5G communication technologies. Application of a cloud radio access network (cloud RAN) as the above-described big data processing technology may also be considered an example of convergence of the 5G technology with the IoT technology. As described above, a plurality of services may be provided to a user in a communication system, and in order to provide such a plurality of services to a user, a method for providing each service within the same time period according to the characteristics and an apparatus using the same are required. Various services provided in the 5G communication system are being studied, and one of the various services is a service that satisfies the requirements for low latency and high reliability. Furthermore, demands for mobile services are explosively increasing, and a location-based service (LBS) led by two requirements including an emergency service and a commercial application is rapidly developing.

The disclosure provides a method and a device for performing positioning (location measurement) when a repeater is used in a wireless mobile communication system. More specifically, an internal delay time that occurs during signal reception and transmission by a repeater may be a factor that hinders accuracy of positioning methods of measuring a time at which a signal is actually transmitted. The disclosure describes methods that can solve this problem.

According to the disclosure, accurate positioning may be made possible by measuring a time at which a signal is actually transmitted.

A repeater may serve to retransmit a signal received from a transmission end, so as to improve signal transfer to a reception end. The transmission end may transmit a positioning signal (positioning reference signal (PRS)) for positioning (location measurement), and this signal may also be forwarded via the repeater. However, an internal delay may occur during signal reception and retransmission by the repeater. An internal delay occurring in a repeater may vary depending on the repeater, but may be a value corresponding to several tens of ns. When time-based positioning is performed, an internal delay occurring in a repeater may have a significant impact on accuracy of positioning. In other words, when a PRS is received via a repeater, positioning accuracy may be degraded due to an internal delay of the repeater. In the disclosure, in order to solve this problem, methods capable of mitigating impact of an internal delay occurring in a repeater when receiving a PRS are described. According to the disclosure, a PRS signal via a repeater may be transmitted with wide coverage while maintaining high positioning accuracy.

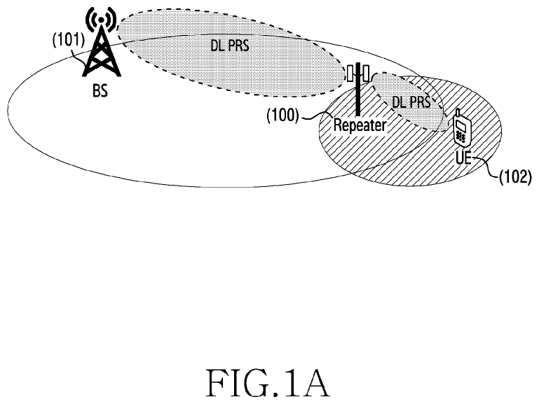

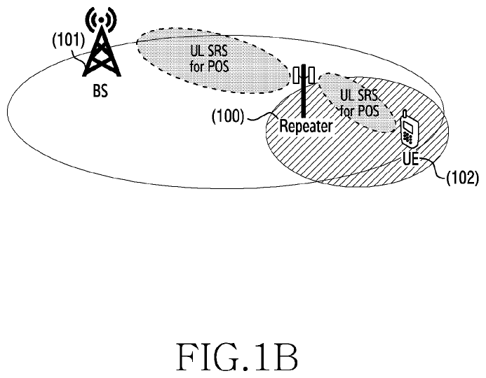

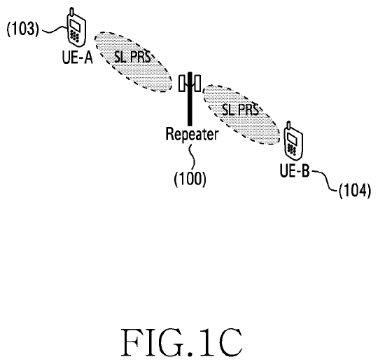

FIG. TA, FIG. 1B, and FIG. 1C are diagrams illustrating a wireless communication system according to an embodiment of the disclosure.

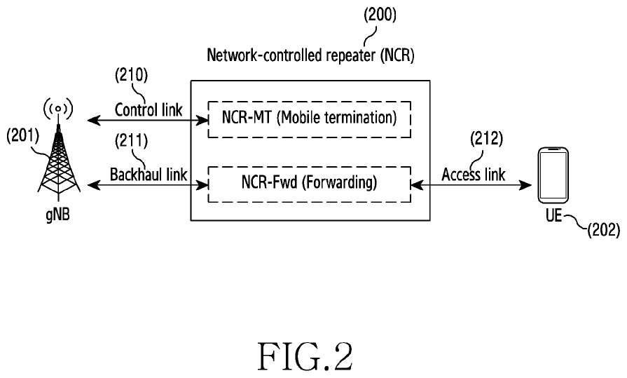

According to FIG. 1A, FIG. 1B, and FIG. 1C, cases where signals are transferred via a repeater 100 during downlink (DL), uplink (UL), and sidelink (SL) transmission are illustrated. Various types of repeaters 100 may be considered in the disclosure. For example, a general radio frequency (RF) repeater may be considered. A general RF repeater may only serve to forward a received signal during signal reception and retransmission. In other words, the repeater may not decode or reprocess the received signal. This case has an advantage of very simple implementation of the repeater. Alternatively, a repeater that decodes or reprocesses a received signal may also be considered. For example, a network-controlled repeater (NCR) may be considered. This will be described in more detail with reference to FIG. 2 below.

In general, a UE is unable to identify whether a received signal has been forwarded by a repeater. However, in the disclosure, a case where a UE is able to identify whether a signal has been forwarded by a repeater is also considered. It is advantageous that a repeater retransmits a received signal so as to improve signal transfer to a reception end. However, there may be an internal delay time that occurs during signal reception and retransmission by the repeater. If a signal received by a repeater is a positioning signal, an internal delay time may be fatal to positioning measurement. This is because an internal delay time of a repeater may be reflected as an error in positioning methods of measuring a time at which a signal is actually transmitted. This may be a factor that reduces accuracy.

FIG. TA illustrates a case where a base station 101 transmits a DL signal to a UE 102 via the repeater 100. As illustrated in FIG. TA, the base station 101 may transmit a DL positioning reference signal (PRS) as a DL signal. The UE 102 having received the DL PRS via the repeater 100 may perform positioning measurement and positioning-related calculation via the DL PRS.

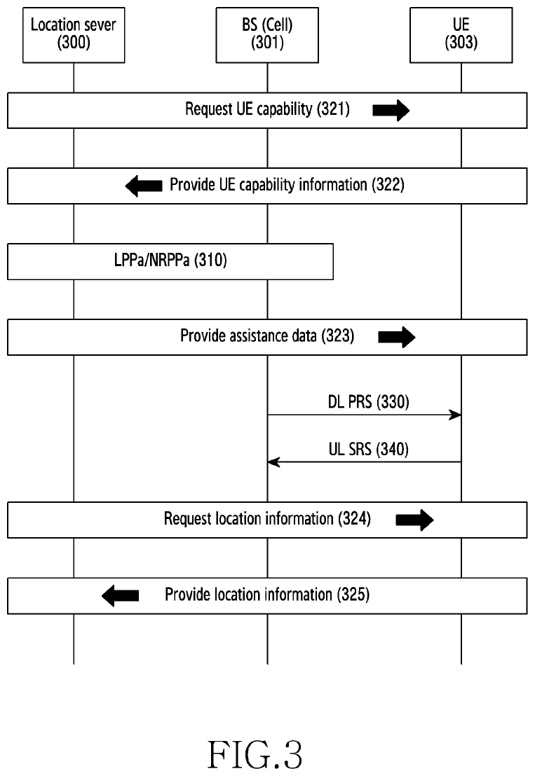

FIG. 1B illustrates a case where the UE 102 transmits a UL signal to the base station 101 via the repeater 100. As illustrated in FIG. 1B, the UE 102 may transmit, as a UL signal, a sounding reference signal (SRS) for positioning measurement. The base station 101 having received the UL SRS via the repeater 100 may perform positioning measurement via the UL SRS. The base station 101 may transfer positioning measurement information to a location server connected to the base station, so that the location server may perform positioning-related calculation. This will be described in detail in FIG. 3.

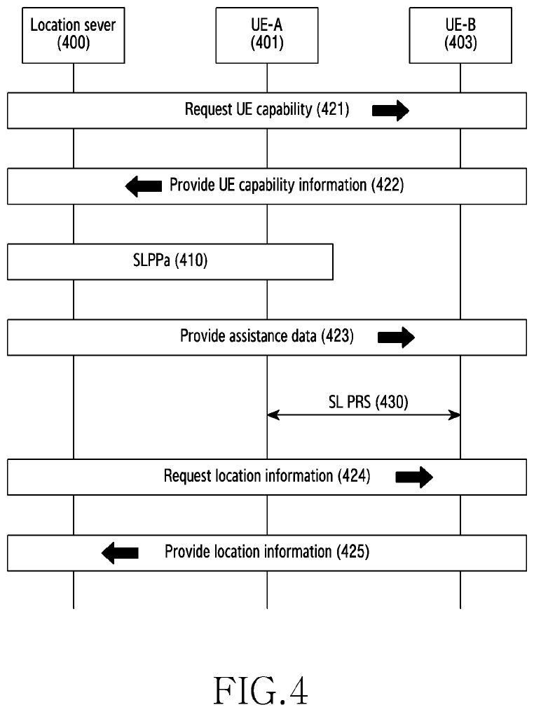

FIG. 1C illustrates a case where a UE 103 transmits an SL signal to another UE 104 via the repeater 100. As illustrated in FIG. 1C, the UE 103 may transmit, as an SL signal, an SL positioning reference signal (PRS) for positioning measurement. The UE 104 having received the SL PRS via the repeater 100 may perform positioning measurement and positioning-related calculation via the SL PRS. Alternatively, the UE 104 may transfer positioning measurement information to a location server connected to the UE and the base station, so that the location server may perform positioning-related calculation. This will be described in detail in FIG. 3 and FIG. 4.

FIG. 2 is a diagram illustrating a network-controlled repeater (NCR) according to an embodiment of the disclosure;

FIG. 2 illustrates a case where a repeater 200 exists between a base station 201 and a UE 202, so that a DL signal or a UL signal may be forwarded via the repeater. For an NCR repeater, unlike a general radio frequency (RF) repeater, the base station 201 and the repeater 200 are connected via a control link (hereinafter, referred to as C-link), so that the NCR repeater has an advantage of enabling network control. Various information for controlling the repeater 200 may be exchanged between the base station 201 and the repeater 200 via the C-link. In addition, referring to FIG. 2, a backhaul link 211 may include a wireless link via which signals are transmitted and received between the base station 201 and the repeater 200. In addition, an access link 212 may include a wireless link via which signals are transmitted and received between the repeater 200 and the UE 202. In the disclosure, information exchanged via the C-link is not limited to specific information. For example, information exchanged via the C-link may include beam-related information. When beam-related information is exchanged, the repeater 200 may forward a signal received from the base station 201 toward the UE 202 by using the beam information when forwarding the signal to the UE 202. This procedure be particularly useful when signal transmission via beamforming is essential in a high-frequency band, such as frequency range2 (FR2). Information additionally required to control the repeater 200 via the C-link according to an embodiment of the disclosure will be described in more detail via the following embodiments.

Hereinafter, a method using a positioning signal (positioning reference signal (PRS)) transmitted via a downlink and an uplink of the UE and the base station is described as a positioning method for measuring a location of the UE. In the disclosure, a method using a positioning signal transmitted via a downlink and an uplink of a UE and a base station may be referred to as radio access technology (RAT)-dependent positioning. In addition, other positioning methods may be classified as RAT-independent positioning. Specifically, for an LTE system, methods, such as observed time difference of arrival (OTDOA), uplink time difference of arrival (UTDOA), and enhanced cell identification (E-CID), may be used as an RAT-dependent positioning technique. For an NR system, methods, such as downlink time difference of arrival (DL-TDOA), downlink angle-of-departure (DL-AOD), multi-round trip time (multi-RTT), NR E-CID, uplink time difference of arrival (UL-TDOA), and uplink angle-of-arrival (UL-AOA), may be used as an RAT-independent positioning technique. In contrast, an RAT-independent positioning technique may include methods involving, such as assisted global navigation satellite systems (A-GNSS), sensor, wireless local area network (WLAN), or Bluetooth.

For RAT-dependent positioning in an interface between base stations and UEs (uplink and downlink, hereinafter, referred to as a Uu interface), a positioning protocol, such as LTE positioning protocol (LPP), LTE positioning protocol annex (LPPa) or NR positioning protocol annex (NRPPa), may be used. LPP may include a positioning protocol defined between a UE and a location server (LS), and LPPa and NRPPa may include a protocol defined between a base station and a location server. Here, the location server is a subject that manages location measurement, and may perform functions of a location management function (LMF). In addition, the location server may also be referred to as LMF or another name. For LTE and NR systems, both systems support LPP, and the following roles for positioning may be performed via LPP.
Positioning capability exchange
Assistance data transmission
Location information transmission
Error processing
Abort

When a UE and a location server perform the above roles via LPP, a base station may function to enable the UE and the location server to exchange positioning information. In this case, exchanging of the positioning information via LPP may be performed transparently to the base station. This may indicate that the base station is not involved in exchanging of the positioning information between the UE and the location server.

For exchanging of positioning capability, the UE may exchange supportable positioning information with the location server. For example, the positioning information supportable by the UE may include whether a positioning method supported by the UE is UE-assisted or UE-based, or whether both thereof are possible. A UE-assisted case indicates a scheme in which the UE, without directly measuring an absolute position of the UE, transfers only a measurement value for a positioning technique to the location server, based on a received positioning signal, and the location server calculates the absolute position of the UE. Here, the absolute position may represent two-dimensional (x, y) and three-dimensional (x, y, z) coordinate location information of the UE according to longitude and latitude. In contrast, a UE-based case may be a scheme in which the UE directly measures an absolute position of the UE, and to this end, while receiving a positioning signal, the UE also needs to receive location information of a subject that transmits the positioning signal. Only the UE-assisted scheme is supported in the LTE system, whereas both UE-assisted and UE-based positioning may be supported in the NR system.

Subsequently, assistance data transmission may be a very important element in positioning for measuring an accurate location of the UE. Specifically, for assistance data transmission, the location server may provide the UE with configuration information for a positioning signal, information on a candidate cell and a transmission reception point (TRP) for reception of the positioning signal, etc. Specifically, when DL-TDOA is used, the information for the candidate cell and TRP for reception of a positioning signal may include information on a reference cell and a reference TRP, information on a neighbor cell and neighbor TRP, etc. In this case, multiple candidates for the neighbor cell and neighbor TRP are provided, and information on which cell and TRP the UE should select to measure the positioning signal may also be provided. In order for the UE to measure an accurate location, it is required to properly select candidate cell and TRP information serving as references. For example, the accuracy of positioning measurement may be increased when a channel for a positioning signal received from a corresponding candidate cell and TRP is a line-of-site (LOS) channel, in other words, a channel having fewer non-LOS (NLOS) channel components. Therefore, when the location server provides the UE with candidate cell and TRP information, which serve as references for performing positioning, by collecting various information, the UE may perform more accurate positioning measurement.

Subsequently, location information transmission may be performed via LPP. The location server may request location information from the UE. The UE may provide the measured location information to the location server in response to the request. For the UE-assisted case, the location information may include a measurement value for the positioning technique based on the positioning signal. In contrast, for the UE-based case, the location information may include two-dimensional (x, y) and three-dimensional (x, y, z) coordinate location values of the UE. When requesting the location information from the UE, the location server may make the request including a required accuracy, response time, etc. as positioning quality of service (QoS) information. When the positioning QoS information is requested, the UE needs to provide the location server with location information measured to satisfy the accuracy and response time, and if it is impossible to satisfy the QoS, error handling and abort may be considered. However, this is merely an example, and error handling and abort for positioning may be performed in a case other than a case where it is impossible to satisfy the QoS.

Subsequently, the positioning protocol defined between the base station and the location server may be referred to as LPPa in the LTE system, and the following functions may be performed between the base station and the location server.
E-CID location information transmission
OTDOA information transmission
General error state reporting
Assistance information transmission

In addition, the positioning protocol defined between the base station and the location server may be referred to as NRPPa in the NR system, and in addition to the above functions performed by LPPa, the following functions may be additionally performed between the base station and the location server.
Positioning information transmission
Measurement information transmission
TRP information transmission

Unlike the LTE system, the NR system supports more positioning techniques. Therefore, various positioning techniques may be supported via positioning information transmission. For example, it is possible for the base station to perform positioning measurement based on a positioning sounding reference signal (SRS) transmitted by the UE. In this case, as positioning information, positioning SRS configuration and activation/deactivation-related information may be exchanged between the base station and the location server.

Subsequently, measurement information transmission refers to a function of exchanging, between the base station and the location server, information related to multi-RTT, UL-TDOA, and UL-AOA which are not supported in the LTE system. Finally, for TRP information transmission, cell-based positioning has been performed in the LTE system, but TRP-based positioning may be performed in the NR system, so that information related to performing TRP-based positioning may be exchanged.

The disclosure also considers a RAT-dependent positioning method supported via a sidelink (SL). RAT-dependent positioning in a Uu interface is possible only when a UE is within coverage of a base station. If a UE performs communication using SL within coverage of a base station, a positioning protocol defined in a Uu interface may be used, and positioning may be performed via a location server. However, RAT-dependent positioning of SL may be possible even when the UE is outside the coverage of the base station. Even in this case, the SL location server and the SL positioning protocol may be defined. Unlike the Uu interface, a UE connected to the location server may exist in SL. Functions of the SL location server and the positioning protocol may be similar to those of the Uu interface.

FIG. 3 is a diagram illustrating a positioning procedure in a Uu interface according to an embodiment of the disclosure.

Referring to FIG. 3, a location server 300 may request UE capability from a UE 303 via LPP in operation 321. The UE 303 may provide supportable positioning information to the location server in operation 322. For example, the UE capability may include whether a positioning method supported by the UE is UE-assisted or UE-based, or whether both thereof are possible.

In addition, the location server 300 and a base station 301 may exchange, via LPPa or NRPPa 310, information required for positioning. For this, reference may be made to the information exchange function between the base station and the location server via LPPa or NRPPa. For example, the base station 301 may provide the location server 300 with positioning measurement information based on a UL SRS 340 received from the UE. In addition, the base station may transmit TX timing error group (TEG) information or RX TEG information of the base station 301 to the location server.

Subsequently, the location server 300 may transmit assistance data to the UE 303 via LPP in operation 323. For this, reference may be made to the functions of LPP.

For example, the base station 301 may transmit, to the UE 303, a DL PRS 330 as positioning information configured by the location server, or the UE 303 may transmit, to the base station 301, the UL SRS 340 as positioning information configured by the location server.

Subsequently, the location server 300 may request location information from the UE 303 via LPP in operation 324.

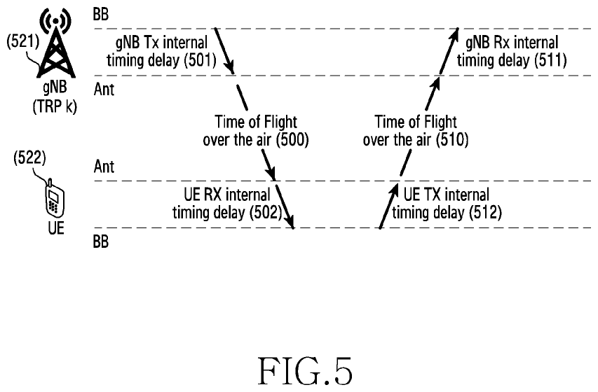

Then, the UE 303 may provide the location information via LPP in operation 325. The location information provided by the UE in operation 325 may be positioning measurement information based on the DL PRS 330 in the case of the UE-assisted scheme. In contrast, the location information provided by the UE in operation 325 may be coordinate location information calculated by the UE in the case of the UE-based scheme. The UE may transmit not only the location information but also the RX TEG information of the UE in operation 325. This will be described in more detail below with reference to FIG. 5.

FIG. 4 is a diagram illustrating a positioning procedure in a sidelink (SL) according to an embodiment of the disclosure.

Referring to FIG. 4, a location server 400 may request, in operation 421, UE capability via a sidelink positioning protocol (SLPP) from a UE 403 which performs positioning measurement and calculation. SLPP is a positioning protocol which enables execution of functions similar or identical to those of LPP described above, but is defined for positioning of a UE located outside base station coverage in SL, and may be referred to as a different name.

The UE 403 may provide supportable positioning information to the location server in operation 422. If the UE 403 is within coverage of a base station, the location server 400 may be connected to the base station. Alternatively, if the UE 403 is outside the base station coverage, the location server 400 may be connected to the UE 403. Alternatively, if the UE 403 is outside the base station coverage, the location server 400 may not be considered, and a UE (e.g., 401) other than the UE 403 may provide functions similar to those of the location server 400. For example, the UE capability may include whether a positioning method supported by the UE 403 is UE-assisted or UE-based, or whether both thereof are possible. In addition, the location server 400 and the UE 401 may exchange information required for positioning via sidelink positioning protocol annex (SLPPa). SLPPa is a positioning protocol which enables execution of functions similar or identical to those of LPPa or NRPPa described above, but is defined for positioning of a UE located outside base station coverage in SL, and may be referred to as a different name. For example, the UE 403 may provide, to the location server 400 connected to the UE 401, positioning measurement information based on an SL PRS 430 received from the UE 401. In addition, the UE may transmit TX timing error group (TEG) information or RX TEG information of the UE 401. This will be described in more detail with reference to FIG. 5 below (in this case, in FIG. 5, a base station may be replaced with UE-A 401 and a UE may be replaced with UE-B 403).

Subsequently, the location server 400 may transmit assistance data to the UE 403 via SLPP in operation 423.

For example, the UE 401 may transmit, to the other UE 403, the SL PRS 430 as positioning information configured by the location server, or the UE 403 may transmit, to the other UE 401, the SL PRS 430 as positioning information configured by the location server.

Subsequently, the location server 400 may request location information from the UE 403 via SLPP in operation 424.

Then, the UE 403 may provide the location information via SLPP in operation 425. The location information provided by the UE in operation 425 may be positioning measurement information based on the SL PRS 430 in the case of the UE-assisted scheme. In contrast, the location information provided by the UE in operation 425 may be coordinate location information calculated by the UE in the case of the UE-based scheme. The UE 403 may transmit, in operation 425, not only the location information but also TX timing error group (TEG) information or RX TEG information of the UE 403. This will be described in more detail with reference to FIG. 5 below (in this case, in FIG. 5, a base station may be replaced with UE-A 401 and a UE may be replaced with UE-B 403).

FIG. 5 is a diagram for describing a timing error and a timing error group (TEG) when a repeater is not considered, according to an embodiment of the disclosure.

The term “TEG” in the disclosure may be replaced by another term that may refer to a timing error or a cause that induces a timing error. TEG may be defined as follows.
TEG is associated with positioning measurement(s) or resource(s) having a timing error difference within a certain margin.

Referring to FIG. 5, descriptions are provided for a positioning method in which, when a base station 521 transmits a positioning signal to a UE 522, the UE 522 measures a time at which the signal has been transmitted. Equation 1 below represents a time of flight (ToF) which is a transmission time of a positioning signal measured by the UE 522 when the signal is transmitted by the base station 521 and received by the UE 522.

$${t}_{UE \_ measurement} = {t}_{k - UE \_ ideal} + {e}_{delay \_ internal} + {e}_{delay \_ propagation} \qquad [ Equation 1 ]$$

In Equation 1, t_{k-UE_ideal} denotes a time (time of flight (ToF)) at which the signal is ideally transmitted without delay through a wireless channel. e_{delay_internal} denotes a value of a timing error that may occur inside the base station and the UE, and the error may occur due to a gNB Tx internal timing delay 501 and a UE Rx internal timing delay 502. However, in the disclosure, a timing error that may occur inside the base station and the UE is not limited to the gNB Tx internal timing delay 501 and the UE Rx internal timing delay 502. Specifically, the gNB Tx internal timing delay 501 is an internal delay that occurs when the base station 521 transmits a positioning signal, and may correspond to a time that takes for a base band (BB) signal to be transmitted as a radio frequency (RF) through an antenna. In addition, the UE Rx internal timing delay 502 is an internal delay that occurs when the UE 522 receives the positioning signal, and may correspond to a time taken for the signal entering as a radio frequency (RF) through an antenna to reach a base band (BB). The base station 521 may provide a location server with a value corresponding to the gNB Tx internal timing delay 501 as a TX timing error group (TEG). In addition, the UE 522 may provide the location server with a value corresponding to the UE Rx internal timing delay 502 as an RX timing error group (TEG). Finally, in Equation 1, e_{delay_propagation} may correspond to a delay that may occur due to interference or blocking by other objects when the signal is actually transmitted through a wireless channel 500.

In addition, referring to FIG. 5, a consideration is made for a positioning method in which, when the UE 522 transmits the positioning signal to the base station 521, the base station 521 measures a time at which the signal has been transmitted. Equation 2 below represents a transmission time of a positioning signal measured by the base station when the signal is transmitted by the UE 522 and received by the base station 521.

$${t}_{BS \_ measurement} = {t}_{UE - k \_ ideal} + {e}_{delay \_ internal} + {e}_{delay \_ propagation} \qquad [ Equation 2 ]$$

In Equation 2, t_{UE-k_ideal} denotes a time (time of flight (ToF)) at which the signal is ideally transmitted without delay through a wireless channel in FIG. 5. e_{delay_internal} denotes a value of a timing error that may occur inside the base station and the UE, and the error may occur due to a UE Tx internal timing delay 512 and a gNB Rx internal timing delay 511. However, in the disclosure, a timing error that may occur inside the base station and the UE is not limited to the UE Tx internal timing delay 512 and the gNB Rx internal timing delay 511. Specifically, the UE Tx internal timing delay 512 is an internal delay that occurs when the UE 522 transmits the positioning signal, and may correspond to a time taken for a base band (BB) signal to be transmitted as a radio frequency (RF) through an antenna. In addition, the gNB Rx internal timing delay 511 is an internal delay that occurs when the base station 521 receives the positioning signal, and may correspond to a time taken for the signal entering as a radio frequency (RF) through an antenna to reach a base band (BB). The UE 522 may provide the location server with a value corresponding to the UE Tx internal timing delay 512 as a TX timing error group (TEG). In addition, the base station 521 may provide the location server with a value corresponding to the gNB Rx internal timing delay 511 as an RX timing error group (TEG). Finally, in Equation 2, e_{delay_propagation} may correspond to a delay that may occur due to interference or blocking by another object in a procedure 510 in which the signal is actually transmitted through a wireless channel.

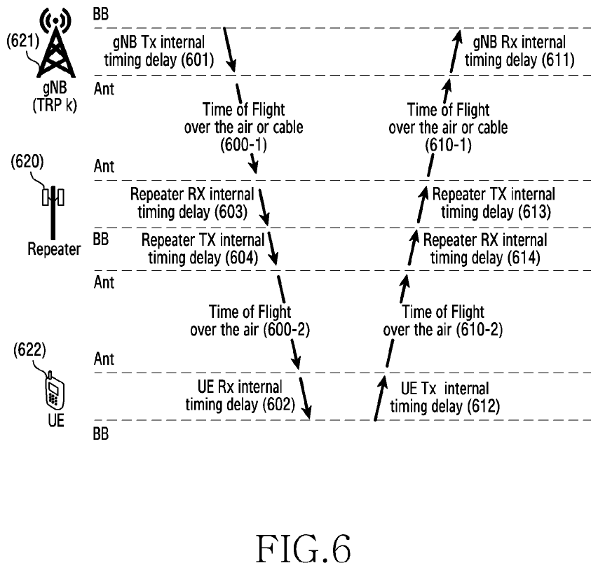

FIG. 6 is a diagram for describing a timing error and a timing error group (TEG) when a repeater is considered, according to an embodiment of the disclosure.

The term “TEG” in the disclosure may be replaced by another term that may refer to a timing error or a cause that induces a timing error. The meaning of TEG is the same as defined above.

Referring to FIG. 6, a consideration is made for a positioning method in which, when a positioning signal transmitted by a base station 621 to a UE 622 is forwarded via a repeater 620, the UE 622 measures a time at which the signal has been transmitted. Equation 3 below represents a transmission time of a positioning signal measured by the UE when the signal is transmitted by the base station 621 and received by the UE 622 via the repeater 620.

$${t}_{UE \_ measurement} = {t}_{k - UE \_ ideal} + {e}_{delay \_ internal} + {e}_{delay \_ repeater \_internal} + {e}_{delay \_ propagation 1} + {e}_{delay \_ propagation 2} \qquad [ Equation 3 ]$$

In Equation 3, t_{k-UE_ideal} denotes a time (time of flight (ToF)) at which the signal is ideally transmitted without delay in FIG. 6.

e_{delay_internal} denotes a value of a timing error that may occur inside the base station and the UE, and the error may occur due to a gNB Tx internal timing delay 601 and a UE Rx internal timing delay 602. However, in the disclosure, a timing error that may occur inside the base station and the UE is not limited to the gNB Tx internal timing delay 601 and the UE Rx internal timing delay 602. Specifically, the gNB Tx internal timing delay 601 is an internal delay that occurs when the base station 621 transmits the positioning signal, and may correspond to a time taken for a base band (BB) signal to be transmitted as a radio frequency (RF) through an antenna. In addition, the UE Rx internal timing delay 602 is an internal delay that occurs when the UE 622 receives the positioning signal, and may correspond to a time taken for the signal entering as a radio frequency (RF) through an antenna to reach a base band (BB). The base station 621 may provide a location server with a value corresponding to the gNB Tx internal timing delay 601 as a TX timing error group (TEG). In addition, the UE 622 may provide the location server with a value corresponding to the UE Rx internal timing delay 602 as an RX timing error group (TEG).

In Equation 3, e_{delay_repeater_internal} denotes a value of a timing error occurred inside the repeater 620, and the error may occur due to a repeater Rx internal timing delay 603 and a repeater Tx internal timing delay 604. However, in the disclosure, a timing error that may occur inside the repeater is not limited to the repeater Rx internal timing delay 603 and the repeater Tx internal timing delay 604. Specifically, the repeater Rx internal timing delay 603 is an internal delay that occurs when the repeater 620 receives the positioning signal, and may correspond to a time taken for the signal entering as a radio frequency (RF) through an antenna to reach a base band (BB). In addition, the repeater Tx internal timing delay 604 is an internal delay that occurs when the repeater 620 transmits the positioning signal, and may correspond to a time taken for a base band (BB) signal to be transmitted as a radio frequency (RF) through an antenna. In the disclosure, values corresponding to the repeater Rx internal timing delay 603 and the repeater Tx internal timing delay 604 are referred to as repeater timing error group (TEG), and details thereof are provided in the following embodiments.

In Equation 3, e_{delay_propagation1} may correspond to a delay that may occur in a procedure 600-1 in which the signal is actually transmitted between the base station and the repeater through a wireless channel or wired channel. For a wireless channel, the delay may occur due to interference or blocking by another object, and for a wired channel, the delay may occur because a cable between the base station and the repeater is not connected in a straight line or because the signal is not transmitted in a straight line within the cable. When a fixed-location base station and repeater are considered, reference is made to the following embodiments for methods of resolving a timing error caused by such delays.

Finally, in Equation 3, e_{delay_propagation2} may correspond to a delay that may occur due to interference or blocking by another object in a procedure 600-2 in which the signal is actually transmitted between the repeater and the UE through a wireless channel.

In addition, referring to FIG. 6, a consideration is made for a positioning method in which, when the UE 622 transmits the positioning signal to the base station 621 via the repeater 620, the base station 621 measures a time at which the signal has been transmitted. Equation 4 below represents a transmission time of a positioning signal measured by the base station when the signal is transmitted by the UE 622, forwarded via the repeater 620, and received by the base station 621.

$${t}_{BS \_ measurement} = {t}_{UE - k \_ internal} + {e}_{delay \_ internal} + {e}_{delay \_ repeater \_internal} + {e}_{delay \_ propagation 1} + {e}_{delay \_ propagation 2} \qquad [ Equation 4 ]$$

In Equation 4, t_{UE-k(TOF)} denotes a time (time of flight (ToF)) at which the signal is ideally transmitted without delay in FIG. 6. e_{delay_internal} denotes a value of a timing error that may occur inside the base station and the UE, and the error may occur due to a UE Tx internal timing delay 612 and a gNB Rx internal timing delay 611. However, in the disclosure, a timing error that may occur inside the base station and the UE is not limited to the UE Tx internal timing delay 612 and the gNB Rx internal timing delay 611. Specifically, the UE Tx internal timing delay 612 is an internal delay that occurs when the UE 622 transmits the positioning signal, and may correspond to a time taken for a base band (BB) signal to be transmitted as a radio frequency (RF) through an antenna. In addition, the gNB Rx internal timing delay 611 is an internal delay that occurs when the base station 621 receives the positioning signal, and may correspond to a time taken for the signal entering as a radio frequency (RF) through an antenna to reach a base band (BB). The UE 622 may provide the location server with a value corresponding to the UE Tx internal timing delay 612 as a TX timing error group (TEG). In addition, the base station 621 may provide the location server with a value corresponding to the gNB Rx internal timing delay 611 as an RX timing error group (TEG). In Equation 4, e_{delay_repeater_internal} denotes a value of a timing error occurred inside the repeater 620, and the error may occur due to a repeater Rx internal timing delay 614 and a repeater Tx internal timing delay 613. However, in the disclosure, a timing error that may occur inside the repeater is not limited to the repeater Rx internal timing delay 614 and the repeater Tx internal timing delay 613. Specifically, the repeater Rx internal timing delay 614 is an internal delay that occurs when the repeater 620 receives the positioning signal, and may correspond to a time taken for the signal entering as a radio frequency (RF) through an antenna to reach a base band (BB). In addition, the repeater Tx internal timing delay 613 is an internal delay that occurs when the repeater 620 transmits the positioning signal, and may correspond to a time taken for a base band (BB) signal to be transmitted as a radio frequency (RF) through an antenna. In the disclosure, values corresponding to the repeater Rx internal timing delay 614 and the repeater Tx internal timing delay 613 are referred to as repeater timing error group (TEG), and details thereof are provided in the following embodiments. In Equation 4, e_{delay_propagation1} may correspond to a delay that may occur in a procedure 610-1 in which the signal is actually transmitted between the base station and the repeater through a wireless channel or wired channel. For a wireless channel, the delay may occur due to interference or blocking by another object, and for a wired channel, the delay may occur because a cable between the base station and the repeater is not connected in a straight line or because the signal is not transmitted in a straight line within the cable. When a fixed-location base station and repeater are considered, reference is made to the following embodiments for methods of resolving a timing error caused by such delays. Finally, in Equation 4, e_{delay_propagation2} may correspond to a delay that may occur due to interference or blocking by another object in a procedure 610-2 in which the signal is actually transmitted between the repeater and the UE through a wireless channel.

As described via Equations 3 and 4, it has been described that an additional timing error may occur due to a repeater when performing positioning. The disclosure proposes methods for solving this problem and mitigating a timing error. One or more of the following embodiments may be used in combination with each other.

### First Embodiment

The first embodiment describes a method of more accurately mitigating a corresponding timing error by exchanging information on an internal delay occurring in a repeater, when a DL signal is received by the repeater, and a DL PRS is also forwarded during retransmission of the signal.

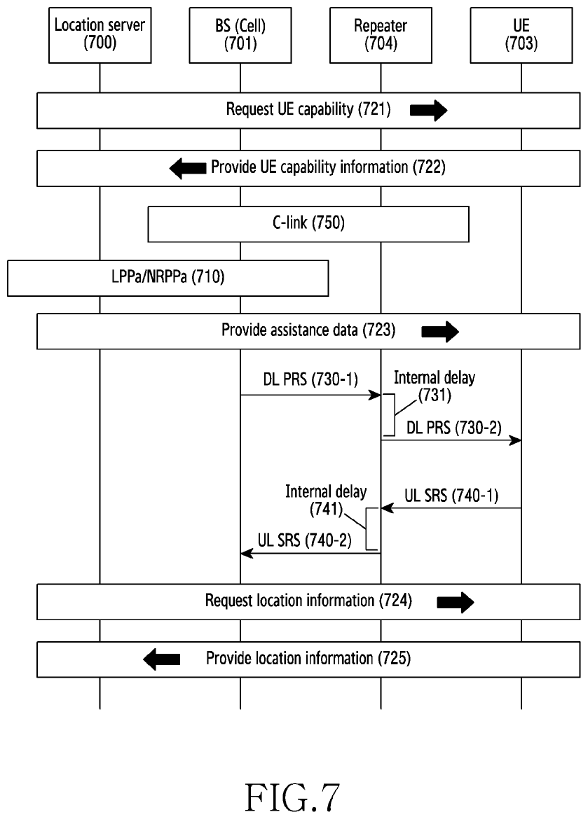

FIG. 7 is a diagram illustrating a positioning procedure considering a repeater in a Uu interface according to an embodiment of the disclosure.

Unlike in FIG. 3, a signal transmitted by a base station 701 may be forwarded to a UE 703 via a repeater 704. Therefore, an LPP message and a DL PRS may be forwarded via the repeater 704. In FIG. 7, a location server 700 may be able to identify approximate locations of the repeater 704 and the UE 703 in advance. This may be possible via a method such as E-CID. Accurate coordinate location information of the repeater 704 may be provided to the base station 701 via a C-link, and the information may be provided to the location server 700 via LPPa or NRPPa. Alternatively, the repeater 704 may be directly connected to the location server 700, and provide the accurate coordinate location information of the repeater 704 to the location server. In the disclosure, the method by which the location server 700 is able to identify approximate locations of the repeater 704 and the UE 703 in advance is not limited to a specific method. If the location server 700 has identified approximate locations of the repeater 704 and the UE 703 in advance, when the location server 700 performs positioning to identify an accurate location (including coordinate information) of the UE 703, for example, when the base station 701 transmits a DL PRS to the UE 703, whether the signal will be transferred to the UE 703 via the repeater 704 may be predicted.

Referring to FIG. 7, the location server 700 may request UE capability from the UE 703 via LPP in operation 721.

The UE 703 may provide supportable positioning information to the location server in operation 722. For example, the UE capability may include whether a positioning method supported by the UE 703 is UE-assisted or UE-based, or whether both thereof are possible.

In addition, as illustrated in FIG. 7, a network-controlled repeater (NCR) may be assumed. Accordingly, the base station 701 and the repeater 704 are connected via the C-link 750, and it is thus advantageous that control through a network is possible. Required information may be exchanged between the base station 701 and the repeater 704 via the C-link 750. For example, the exchanged information may include the following information. However, the information exchanged between the base station 701 and the repeater 704 via the C-link 750 in the disclosure is not limited to the following.
Coordinate location information of the repeater 704
Repeater identification information: Refer to the repeater identification information described below.
Information on an internal delay occurring in the repeater 704 (which may correspond to e_{delay_repeater_internal} in Equation 3): The information may be values corresponding to the repeater Rx internal timing delay 603 and the repeater Tx internal timing delay 604 in FIG. 6, and may be referred to as repeater timing error group (TEG). Repeater TEG may be a value distinct from the base station TX/RX TEG or UE TX/RX TEG described via FIG. 5. The term “repeater TEG” in the disclosure may be replaced by another term that may refer to a timing error or another element that causes a timing error.
Information on propagation delay occurring in the base station 701 and the repeater 704 (corresponding to e_{delay_propagation1} in Equation 3): When a fixed-location base station and repeater are considered, a distance between the base station and repeater is fixed, so that a value of the timing error (corresponding to e_{delay_propagation1} in Equation 3) that may occur in the procedure 600-1 of FIG. 6 may be measured and identified in advance. Here, the information on propagation delay occurring in the base station 701 and the repeater 704 may be replaced with another term referring to the same. Alternatively, instead of the information on propagation delay, other terms referring to ToF information and information on the distance between the base station 701 and repeater 704 may be used as replacement.

Subsequently, the location server 700 and the base station 701 may exchange, via LPPa or NRPPa 710, information required for positioning. For this, reference may be made to the information exchange function between the base station and the location server via LPPa or NRPPa. For example, the exchanged information may include the following information. However, the information exchanged between the base station 701 and the location server 700 via the LPPa or NRPPa 710 in the disclosure is not limited to the following.
Repeater coordinate location information
Repeater TEG information
Repeater identification information: Here, repeater identification information may refer to repeater identification (ID) information. The repeater ID may be explicitly defined and indicated similarly to a cell ID. Alternatively, the repeater ID may be identification information that is not explicitly defined but enables the base station and the location server to distinguish the repeater. Based on the repeater identification information, the base station and the location server may be able to analyze and distinguish repeater coordinate location information and repeater TEG information. In addition, the information may include information enabling identification of a repeater type. For example, the repeater type may include a general RF repeater, an NCR, or an integrated access and backhaul (IAB). Based on the identification information, the location server and the base station may exchange information required according to the type of repeater in an environment where different repeaters are mixed.
Base station TX TEG information (which may be a value corresponding to the gNB Tx internal timing delay 601 in FIG. 6.)
Information on propagation delay occurring in the base station 701 and the repeater 704 (corresponding to e_{delay_propagation1} in Equation 3): Here, the information on propagation delay occurring in the base station 701 and the repeater 704 may be replaced with another term referring to the same. Alternatively, instead of the information on propagation delay, other terms referring to ToF information and information on the distance between the base station 701 and repeater 704 may be used as replacement.

If the repeater 704 is directly connected to the location server 700, the repeater coordinate location information and the repeater TEG information may be provided directly to the location server 700 without going through the base station 701.

Subsequently, the location server 700 may transmit assistance data to the UE 703 via LPP in operation 723. For this, reference may be made to the functions of LPP. For example, the assistance data may include the following information. The information provided as the assistance data between the location server 700 and the UE 703 in the disclosure is not limited to the following.
DL PRS 730 configuration information
Repeater TEG information (which may be provided only for UE-based positioning)
Base station TX TEG information (which may be provided only for UE-based positioning)
Information on propagation delay occurring in the base station 701 and the repeater 704 (which corresponds to e_{delay_propagation1} in Equation 3, and may be provided only for UE-based positioning): Here, the information on propagation delay occurring in the base station 701 and the repeater 704 may be replaced with another term referring to the same. Alternatively, instead of the information on propagation delay, other terms referring to ToF information and information on the distance between the base station 701 and repeater 704 may be used as replacement.

Since each UE has a different location, and some UEs receive signals from a base station via a repeater while others do not, repeater TEG information may be information UE-dedicatedly (or UE-specifically) applied to a UE. In addition, the following alternatives may be considered for the repeater TEG information provided via assistance data. However, the repeater TEG information in the disclosure is not limited to the following alternatives.
Alternative 1: Repeater TEG information is provided in addition to TX TEG information (repeater TEG information may be provided only for UE-based positioning)
Alternative 2: Repeater TEG information is provided separately from TX TEG information (repeater TEG information may be provided only for UE-based positioning)

When the information on propagation delay occurring in the base station 701 and the repeater 704 is provided also via assistance data, the following alternatives may be considered. However, the disclosure is not limited to the following alternatives.
Alternative 1: Propagation delay information is provided in addition to TX TEG information (propagation delay information may be provided only for UE-based positioning)
Alternative 2: Propagation delay information is provided separately from TX TEG information (propagation delay information may be provided only for UE-based positioning)

The above alternatives may also be considered when both repeater TEG information and propagation delay information are provided via assistance data.

Subsequently, the location server 700 may request location information from the UE 703 via LPP in operation 724.

Then, the UE 703 may provide the location information to the location server via LPP in operation 725. In operation 725, as a method for mitigating a timing error, the UE may perform location measurement using the repeater TEG information or TX TEG information described above. In addition, the location information provided by the UE 703 in operation 725 may include positioning measurement information based on the DL PRS 730 for the UE-assisted scheme. In the UE-assisted scheme, the location server 700 may calculate a coordinate location of the UE, based on the positioning measurement information provided by the UE 703. In contrast, for the UE-based scheme, the UE 703 may directly calculate a coordinate location and provide the coordinate location as the location information. In particular, for the UE-assisted scheme, the UE 703 may transmit not only the location information but also the RX TEG information of the UE 703 (which may be a value corresponding to 602 of FIG. 6) in operation 725. In an embodiment, a point in time at which TEG information is provided is described, but in the disclosure, a point in time at which TEG information is provided is not limited to a specific time point and operation.

In FIG. 7, the UE 703 is generally unable to identify whether the signal has been received by being forwarded via the repeater 704 or received directly from the base station 701 without going through the repeater 704. However, the UE 703 may indirectly (implicitly) identify, via the repeater TEG information, whether the signal has been received by being forwarded via the repeater 704 or received directly from the base station 701 without going through the repeater 704. In addition, the disclosure is not limited thereto. In other words, embodiments of the disclosure may include a case where, when a signal is received, the UE 703 may directly (explicitly) identify, based on additional information, whether the signal has been received by being forwarded via the repeater 704. In the disclosure, the method by which the UE identifies this information is not limited to a specific method. If the UE 703 is able to determine whether the received signal has been forwarded via the repeater 704, the UE 703 may determine whether to apply the repeater TEG information when performing positioning measurement. In other words, positioning measurement may be performed by applying repeater TEG only for a signal received by being forwarded via the repeater 704.

A method performed by a repeater in a wireless communication system according to an embodiment of the disclosure may include: transmitting, to a base station, control information including location information of the repeater, identification information of the repeater, repeater TEG information for a delay occurring inside the repeater, and propagation delay information for a delay occurring while a downlink (DL) positioning reference signal (PRS) is being transmitted between the base station and the repeater; receiving the DL PRS and assistance data from the base station; and transmitting the DL PRS and the assistance data to a UE. The assistance data may include configuration information of the DL PRS, the repeater TEG information, base station TEG information for a delay occurring inside the base station, and the propagation delay information for a delay occurring while the DL PRS is being transmitted between the base station and the repeater. Location information of the UE may be based on the DL PRS and the assistance data.

A method performed by a repeater in a wireless communication system according to an embodiment of the disclosure may include: transmitting, to a location server, location information of the repeater and repeater TEG information for a delay occurring inside the repeater; receiving a downlink (DL) positioning reference signal (PRS) and assistance data from the base station; and transmitting the DL PRS and the assistance data to a UE. The assistance data may include configuration information of the DL PRS, the repeater TEG information, base station TEG information for a delay occurring inside the base station, and the propagation delay information for a delay occurring while the DL PRS is being transmitted between the base station and the repeater. Location information of the UE may be based on the DL PRS and the assistance data.

### Second Embodiment

The second embodiment describes a method of more accurately mitigating a corresponding timing error by exchanging information on an internal delay occurring in a repeater, when a UL signal is received by the repeater, and a UL SRS for positioning is also forwarded during retransmission of the signal.

FIG. 7 is a diagram illustrating a positioning procedure considering a repeater in a Uu interface according to an embodiment of the disclosure.

Unlike in FIG. 3, a signal transmitted by the UE 703 may be forwarded to the base station 701 via the repeater 704. Therefore, an LPP message and a UL SRS for positioning may be forwarded via the repeater. In FIG. 7, the location server 700 may be able to identify approximate locations of the repeater 704 and the UE 703 in advance. This may be possible via a method such as E-CID. Accurate coordinate location information of the repeater 704 may be provided to the base station 701 via a C-link, and the information may be provided to the location server 700 via LPPa or NRPPa. Alternatively, the repeater 704 may be directly connected to the location server 700, and provide the accurate coordinate location information of the repeater 704 to the location server 700.

In the disclosure, the method by which the location server 700 is able to identify approximate locations of the repeater 704 and the UE 703 in advance is not limited to a specific method. If the location server 700 has identified approximate locations of the repeater 704 and the UE 703 in advance, when the location server 700 performs positioning to identify an accurate location (including coordinate information) of the UE 703, for example, when the UE 703 transmits a UL SRS to the base station 701, whether the signal will be transferred to the UE 703 via the repeater 704 may be predicted.

Referring to FIG. 7, the location server 700 may request UE capability from the UE 703 via LPP in operation 721.

The UE 703 may provide supportable positioning information to the location server in operation 722. For example, the UE capability may include whether a positioning method supported by the UE 703 is UE-assisted or UE-based, or whether both thereof are possible. In addition, as illustrated in FIG. 7, a network-controlled repeater (NCR) may be assumed. Accordingly, the base station 701 and the repeater 704 are connected via the C-link 750, and it is thus advantageous that control through a network is possible. Required information may be exchanged between the base station 701 and the repeater 704 via the C-link 750. For example, the exchanged information may include the following information. However, the information exchanged between the base station 701 and the repeater 704 via the C-link 750 in the disclosure is not limited to the following.
Coordinate location information of the repeater 704
Repeater identification information: Refer to the repeater identification information described below.
Information on an internal delay occurring in the repeater 704 (which may correspond to e_{delay_repeater_internal} in Equation 4): The information may be values corresponding to the repeater Tx internal timing delay 613 and the repeater Rx internal timing delay 614 in FIG. 6, and may be referred to as repeater timing error group (TEG). Repeater TEG may be a value distinct from the base station TX/RX TEG or UE TX/RX TEG described via FIG. 5. The term “repeater TEG” in the disclosure may be replaced by another term that may refer to a timing error or another element that causes a timing error.
Information on propagation delay occurring in the base station 701 and the repeater 704 (corresponding to e_{delay_propagation1} in Equation 4): When a fixed-location base station and repeater are considered, a distance between the base station and repeater is fixed, so that a value of the timing error (corresponding to e_{delay_propagation1} in Equation 4) that may occur in 610-1 of FIG. 6 may be measured and identified in advance. Here, the information on propagation delay occurring in the base station 701 and the repeater 704 may be replaced with another term referring to the same. Alternatively, instead of the information on propagation delay, other terms referring to ToF information and information on the distance between the base station 701 and repeater 704 may be used as replacement.

Subsequently, the location server 700 and the base station 701 may exchange, via the LPPa or NRPPa 710, information required for positioning. For this, reference may be made to the information exchange function between the base station and the location server via LPPa or NRPPa. For example, the exchanged information may include the following information. However, the information exchanged between the base station 701 and the location server 700 via the LPPa or NRPPa 710 in the disclosure is not limited to the following.
Repeater coordinate location information
Repeater TEG information
Repeater identification information: Here, repeater identification information may refer to repeater identification (ID) information. The repeater ID may be explicitly defined and indicated similarly to a cell ID. Alternatively, the repeater ID may be identification information that is not explicitly defined but enables the base station and the location server to distinguish the repeater. Based on the repeater identification information, the base station and the location server may be able to analyze and distinguish repeater coordinate location information and repeater TEG information. In addition, the information may include information enabling identification of a repeater type. For example, the repeater type may include a general RF repeater, an NCR, or an integrated access and backhaul (IAB). Based on the identification information, the location server and the base station may exchange information required according to the type of repeater in an environment where different repeaters are mixed.
Base station RX TEG information (which may be a value corresponding to the gNB Rx internal timing delay 611 in FIG. 6.)
Information on propagation delay occurring in the base station 701 and the repeater 704 (corresponding to e_{delay_propagation1} in Equation 4): Here, the information on propagation delay occurring in the base station 701 and the repeater 704 may be replaced with another term referring to the same. Alternatively, instead of the information on propagation delay, other terms referring to ToF information and information on the distance between the base station 701 and repeater 704 may be used as replacement. If the information is not included, the base station may have already applied a timing error value corresponding to the propagation delay at positioning measurement.

If the repeater 704 is directly connected to the location server 700, the repeater coordinate location information and the repeater TEG information may be provided directly to the location server 700 without going through the base station 701.

Subsequently, the location server 700 may transmit assistance data to the UE 703 via LPP in operation 723. For this, reference may be made to the functions of LPP. For example, the assistance data may include the following information. The information provided as the assistance data between the location server 700 and the UE 703 in the disclosure is not limited to the following.
UL SRS 740 configuration information

Subsequently, the location server 700 may request location information from the UE 703 via LPP in operation 724.

Then, the UE 703 may transmit a UL SRS for positioning via LPP in operation 725. The UE may transmit TX TEG information of the UE 703 (which may be a value corresponding to the UE Tx internal timing delay 612 of FIG. 6) as well as the UL SRS in operation 725. Unlike the first embodiment, in the method of the second embodiment, the base station 701 may perform positioning measurement using the UL SRS, and the location server 700 may calculate a coordinate location of the UE based on the positioning measurement information that the base station 701 has provided to the location server 700. When the base station 701 performs positioning measurement using the UL SRS or when the location server 700 calculates the position of the UE 703, whether an internal delay occurring in the repeater 704 should be considered may be determined. The internal delay occurring in the repeater 704 may be applied as a value of the repeater TEG. Since each UE has a different location, and the base station 701 may or may not receive a signal via the repeater 704, repeater TEG information may be information UE-dedicatedly (or UE-specifically) applied to the UE. In an embodiment, a point in time at which TEG information is provided is described, but in the disclosure, a point in time at which TEG information is provided is not limited to a specific time point and operation.

In FIG. 7, the base station 701 is generally unable to identify whether the signal has been received by being forwarded via the repeater 704 or received directly from the UE 703 without going through the repeater 704. However, the base station 701 may indirectly (implicitly) identify, via the repeater TEG information, whether the signal has been received by being forwarded via the repeater 704 or received directly from the UE 703 without going through the repeater 704. In addition, the disclosure is not limited thereto. In other words, embodiments of the disclosure may include a case where, when the base station 701 receives a signal, the base station 701 and the location server 700 may directly (explicitly) identify, based on additional information, whether the signal has been received by being forwarded via the repeater 704. In the disclosure, the method by which the base station and the location server identify corresponding information is not limited to a specific method. If the base station 701 and the location server 700 are able to determine whether the received signal of the base station has been forwarded via the repeater 704, the base station 701 and the location server 700 may determine whether to apply the repeater TEG information when performing positioning measurement. In other words, positioning measurement may be performed by applying repeater TEG only for a signal received by being forwarded via the repeater 704.

### Third Embodiment

The third embodiment describes a method of more accurately mitigating a corresponding timing error by exchanging information on an internal delay occurring in a repeater, when an SL signal is received by the repeater, and an SL PRS is also forwarded during retransmission of the signal.

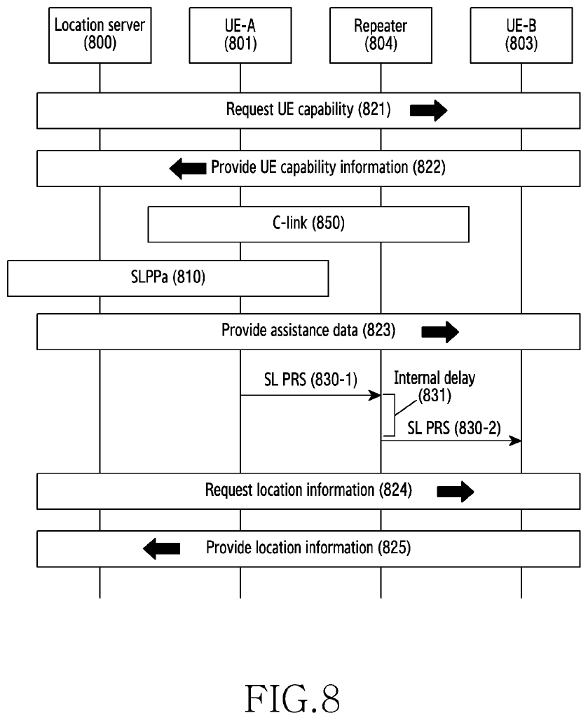

FIG. 8 is a diagram illustrating a positioning procedure considering a repeater in an SL according to an embodiment of the disclosure.

Unlike in FIG. 4, a signal transmitted by a UE 801 may be forwarded to another UE 803 via a repeater 804. Therefore, an SLPP message and an SL PRS for positioning may be forwarded via the repeater 804. In FIG. 8, a location server 800 may be able to identify approximate locations of the repeater 804 and the UE 803 in advance. This may be possible via a method similar to E-CID. Accurate coordinate location information of the repeater 804 may be provided to the UE (UE-A) 801 via a C-link, and the information may be provided to the location server 800 via SLPPa. Alternatively, the repeater 804 may be directly connected to the location server 800 that is connected to the UE 801, and may provide the accurate coordinate location information of the repeater 804 to the location server 800. However, in SL, the location server 800 may not be considered if the UE 803 is outside coverage of the base station. In this case, the other UE 801 may perform functions similar to those of the location server 800.

In the disclosure, the method by which the location server 800 is able to identify approximate locations of the repeater 804 and the UE in advance is not limited to a specific method. If the location server 800 has identified approximate locations of the repeater 804 and the UE (UE-B) 803 in advance, when the location server 800 performs positioning to identify an accurate location (including coordinate information) of the UE (UE-B) 803, for example, when the UE (UE-A) 801 transmits an SL PRS to another UE (UE-B) 803, whether the signal will be transferred to the other UE (UE-B) 803 via the repeater 804 may be predicted.

Referring to FIG. 8, the location server 800 may request, in operation 821, UE capability via a sidelink positioning protocol (SLPP) from the UE 803 which performs positioning measurement and calculation. SLPP is a positioning protocol which enables execution of functions similar or identical to those of LPP, but is defined for positioning of a UE located outside base station coverage in SL, and may be referred to as a different name.

The UE 803 may provide supportable positioning information to the location server 800 in operation 822. If the UE 803 is within coverage of a base station, the location server 800 may be connected to the base station. Alternatively, if the UE 803 is outside the base station coverage, the location server 800 may be connected to the UE 801. Alternatively, if the UE 803 is outside the base station coverage, the location server 800 may not be considered, and a UE (e.g., the UE (UE-A) 801) other than the UE (UE-B) 803 may provide functions similar to those of the location server 800. For example, the UE capability may include whether a positioning method supported by the UE is UE-assisted or UE-based, or whether both thereof are possible. In addition, as illustrated in FIG. 8, a network-controlled repeater (NCR) may be assumed. Accordingly, the UE 801 and the repeater 804 are connected via the C-link 850, and it is thus advantageous that control through a network is possible. Required information may be exchanged between the UE 801 and the repeater 804 via the C-link 850. For example, the exchanged information may include the following information. However, the information exchanged between the UE 801 and the repeater 804 via the C-link 850 in the disclosure is not limited to the following.
Coordinate location information of the repeater 804
Repeater identification information: Refer to the repeater identification information described below.
Information on an internal delay occurring in the repeater 804: The information may be referred to as repeater timing error group (TEG). Repeater TEG may be a value distinct from the base station TX/RX TEG or UE TX/RX TEG described via FIG. 5. The term “repeater TEG” in the disclosure may be replaced by another term that may refer to a timing error or another element that causes a timing error.

Subsequently, the location server 800 and the UE 801 may exchange information required for positioning via sidelink positioning protocol annex (SLPPa). SLPPa is a positioning protocol which enables execution of functions similar or identical to those of LPPa or NRPPa, but is defined for positioning of a UE located outside base station coverage in SL, and may be referred to as a different name. For example, the exchanged information may include the following information. However, the information exchanged between the UE 801 and the location server 800 via the SLPPa in the disclosure is not limited to the following.
Repeater coordinate location information
Repeater TEG information
Repeater identification information: Here, repeater identification information may refer to repeater identification (ID) information. The repeater ID may be explicitly defined and indicated similarly to a cell ID. Alternatively, the repeater ID may be identification information that is not explicitly defined but enables the base station and the location server to distinguish the repeater. Based on the repeater identification information, the base station and the location server may be able to analyze and distinguish repeater coordinate location information and repeater TEG information. In addition, the information may include information enabling identification of a repeater type. For example, the repeater type may include a general RF repeater, an NCR, or an integrated access and backhaul (IAB). Based on the identification information, the location server and the base station may exchange information required according to the type of repeater in an environment where different repeaters are mixed.
TX/RX TEG information of the UE 801 (In FIG. 6, the base station is replaced with UE-A 621 and the UE is replaced with UE-B 622, so that the gNB Tx internal timing delay 601 and gNB Rx internal timing delay 611 in FIG. 6 may be values corresponding to TX/RX TEG of UE-A 621, respectively.)

If the repeater 804 is directly connected to the location server 800, the repeater coordinate location information and the repeater TEG information may be provided directly to the location server 800 without going through the UE 801. In contrast, if the UE (e.g. 801) other than the UE 803 provides functions similar to those of the location server 800, the repeater coordinate location information, the repeater TEG information, and the TX/RX TEG information of the UE 801 may be provided to the other UE.

Subsequently, the location server 800 may transmit assistance data to the UE 803 via the SLPP in operation 823. For example, the assistance data may include the following information. The information provided as the assistance data between the location server 800 and the UE 803 in the disclosure is not limited to the following.
SL PRS 830 configuration information
Repeater TEG information (which may be provided only for UE-based positioning)
TX/RX TEG information of the UE 801 (which may be provided only for UE-based positioning)

Since each UE has a different location, and some UEs transmit and receive signals via a repeater while others do not, repeater TEG information may be information UE-dedicatedly (or UE-specifically) applied to a UE. In addition, the following alternatives may be considered for the repeater TEG information provided via assistance data. However, the repeater TEG information in the disclosure is not limited to the following alternatives.
Alternative 1: Repeater TEG information is provided in addition to TX TEG information (repeater TEG information may be provided only for UE-based positioning)
Alternative 2: Repeater TEG information is provided separately from TX TEG information (repeater TEG information may be provided only for UE-based positioning)

Subsequently, the location server 800 may request location information from the UE 803 via the SLPP in operation 824.

Then, the UE 803 may provide the location information via the SLPP in operation 825. In operation 825, as a method for mitigating a timing error, the UE 803 may perform location measurement using the repeater TEG information or TX TEG information described above. In addition, the location information provided by the UE 803 in operation 825 may be positioning measurement information based on the SL PRS 830 for the UE-assisted scheme. In the UE-assisted scheme, the location server 800 may calculate a coordinate location of the UE 803, based on the positioning measurement information provided by the UE 803. In contrast, for the UE-based scheme, the UE 803 may directly calculate a coordinate location and provide the coordinate location as the location information. In particular, for the UE-assisted scheme, the UE 803 may transmit not only the location information but also the TX/RX TEG information of the UE 803 in operation 825. In an embodiment, a point in time at which TEG information is provided is described, but in the disclosure, a point in time at which TEG information is provided is not limited to a specific time point and operation.

In FIG. 8, the UE 803 is generally unable to identify whether the signal has been received by being forwarded via the repeater 804 or received directly from the UE 801 without going through the repeater 804. However, the UE 803 may indirectly (implicitly) identify, via the repeater TEG information, whether the signal has been received by being forwarded via the repeater 804 or received directly from the UE 801 without going through the repeater 804. In addition, the disclosure is not limited thereto. In other words, embodiments of the disclosure may include a case where, when a signal is received, the UE 803 may directly (explicitly) identify, based on additional information, whether the signal has been received by being forwarded via the repeater 804. In the disclosure, the method by which the UE 803 identifies corresponding information is not limited to a specific method. If the UE 803 is able to determine whether the received signal has been forwarded via the repeater 804, the UE 803 may determine whether to apply the repeater TEG information when performing positioning measurement. In other words, positioning measurement may be performed by applying repeater TEG only for a signal received by being forwarded via the repeater 804.

A method performed by a first UE (terminal) in a wireless communication system according to an embodiment of the disclosure may include: receiving assistance data from a location server by using a sidelink positioning protocol defined between the first UE and a second UE; receiving a sidelink (SL) positioning reference signal (PRS) from the second UE via a repeater; receiving a request for a location of the first UE from the location server; based on the SL PRS, acquiring a measurement value related to the location of the first UE; and transmitting the measurement value or location information of the first UE to the location server, the location information being based on the assistance data and the measurement value, wherein the assistance data includes configuration information of the SL PRS, repeater timing error group (TEG) information for a delay occurring inside the repeater, second UE TEG information for a delay occurring inside the second UE, and propagation delay information on a delay occurring between the second UE and the repeater.

The acquiring of the measurement value may include measuring a time taken for the SL PRS to be transmitted from the second UE to the first UE.

When transmitting the measurement value to the location server, the method may further include transmitting, to the location server, first UE TEG information on a delay occurring inside the first UE.

When transmitting the location information of the first UE to the location server, the method may further include calculating the location of the first UE based on the assistance data and the measurement value so as to acquire the location information.

The method may further include: acquiring multiple measurement values for multiple SL PRSs; and based on the repeater TEG information, identifying that the SL PRS among the multiple SL PRSs has been received by being forwarded via the repeater, wherein the transmitting of the measurement value and the location information may include transmitting the measurement value or the location information by preferentially considering measurement values remaining after excluding the measurement value for the SL PRS among the multiple measurement values.

A method performed by a repeater in a wireless communication system according to an embodiment of the disclosure may include: exchanging, with a first UE, control information including location information of the repeater, identification information of the repeater, and repeater TEG information for a delay occurring inside the repeater; receiving a sidelink (SL) positioning reference signal (PRS) and assistance data from the first UE; and transmitting the SL PRS and the assistance data to the second UE. The assistance data may include configuration information of the SL PRS, the repeater TEG information, and first UE TEG information for a delay occurring inside the first UE. Location information of the second UE may be based on the SL PRS and the assistance data.

A method performed by a repeater in a wireless communication system according to an embodiment of the disclosure may include: transmitting, to a location server, location information of the repeater and repeater TEG information for a delay occurring inside the repeater; receiving a sidelink (SL) positioning reference signal (PRS) and assistance data from the first UE; and transmitting the SL PRS and the assistance data to the second UE. The assistance data may include configuration information of the SL PRS, the repeater TEG information, and first UE TEG information for a delay occurring inside the first UE. Location information of the second UE may be based on the SL PRS and the assistance data.

### Fourth Embodiment

The fourth embodiment describes a method of mitigating a timing error without explicitly exchanging information on delay error causes, such as a propagation delay and an internal delay occurred in a repeater, when a DL signal is received by the repeater, and a DL PRS is also forwarded during retransmission of the signal. Here, the fact that the information on delay error causes is not explicitly exchanged may be interpreted as the C-link 750 in FIG. 7 not being taken into account. However, the base station and the repeater may exchange the information on delay error causes in an implementation-specific manner.

FIG. 7 is a diagram illustrating a positioning procedure considering a repeater in a Uu interface according to an embodiment of the disclosure.

Unlike in FIG. 3, a signal transmitted by the base station 701 may be forwarded to the UE 703 via the repeater 704. Therefore, an LPP message and a DL PRS may be forwarded via the repeater 704. In FIG. 7, the location server 700 may be able to identify approximate locations of the repeater 704 and the UE 703 in advance. This may be possible via a method such as E-CID. This may be possible via a method such as E-CID. In the disclosure, the method by which the location server 700 is able to identify approximate locations of the repeater 704 and the UE 703 in advance is not limited to a specific method. If the location server 700 has identified approximate locations of the repeater 704 and the UE 703 in advance, when the location server 700 performs positioning to identify an accurate location (including coordinate information) of the UE 703, for example, when the base station 701 transmits a DL PRS to the UE 703, whether the signal will be transferred to the UE 703 via the repeater 704 may be predicted.

In the embodiment, the C-link 750 in FIG. 7 may not be considered. Accordingly, unlike the first embodiment, an environment is considered in which it is difficult for the base station and the location server to control the repeater via information exchange with the repeater.

Referring to FIG. 7, the location server 700 may request UE capability from the UE 703 via LPP in operation 721. The UE 703 may provide supportable positioning information to the location server in operation 722. For example, the UE capability may include whether a positioning method supported by the UE 703 is UE-assisted or UE-based, or whether both thereof are possible.

Subsequently, the location server 700 and the base station 701 may exchange, via the LPPa or NRPPa 710, information required for positioning. For this, reference may be made to the information exchange function between the base station and the location server via LPPa or NRPPa. When the base station and the repeater are able to exchange information on delay error causes, such as a propagation delay and an internal delay occurred in the repeater, including repeater coordinate location information and repeater identification information, the information presented in the first embodiment may be exchanged between the base station and the location server via LPPa or NRPPa.

Subsequently, the location server 700 may transmit assistance data to the UE 703 via LPP in operation 723. For this, reference may be made to the functions of LPP. For example, the assistance data may include the following information. The information provided as the assistance data between the location server 700 and the UE 703 in the disclosure is not limited to the following.
DL PRS 730 configuration information
Repeater TEG information (which may be provided only for UE-based positioning)
Base station TX TEG information (which may be provided only for UE-based positioning)
Information on propagation delay occurring in the base station 701 and the repeater 704 (which corresponds to e_{delay_propagation1} in Equation 3, and may be provided only for UE-based positioning): Here, the information on propagation delay occurring in the base station 701 and the repeater 704 may be replaced with another term referring to the same. Alternatively, instead of the information on propagation delay, other terms referring to ToF information and information on the distance between the base station 701 and repeater 704 may be used as replacement.

The repeater TEG information refers to information on an internal delay occurring in the repeater. Since each UE has a different location, and some UEs receive signals from a base station via a repeater while others do not, repeater TEG information may be information UE-dedicatedly (or UE-specifically) applied to a UE. In addition, the following alternatives may be considered for the repeater TEG information provided via assistance data. However, the repeater TEG information in the disclosure is not limited to the following alternatives.
Alternative 1: Whether the UE should consider an internal delay occurring in the repeater (this may be provided only for UE-based positioning)
Alternative 2: Repeater TEG information is provided in addition to TX TEG information (repeater TEG information may be provided only for UE-based positioning)
Alternative 3: Repeater TEG information is provided separately from TX TEG information (repeater TEG information may be provided only for UE-based positioning)

For alternative 1, whether the UE should consider an internal delay occurring in the repeater may be indicated by 1-bit information. A case where the UE should consider an internal delay occurring in the repeater may be a case where a signal transmitted by the base station is transferred to the UE via the repeater. If it is indicated, in alternative 1, that an internal delay occurring in the repeater should be considered, the UE may de-prioritize a corresponding measurement result from a positioning measurement result candidate list. In other words, a positioning measurement result for a signal received without going through the repeater may be treated to have a higher priority than a positioning measurement result for a signal received through the repeater, and this may be reflected when reporting a measurement result to the location server. This may be interpreted as an operation in which the UE reports, as a more preferred (prioritized) measurement result, a signal result received without going through the repeater from the positioning measurement result candidate list. Whether a signal received by the UE is forwarded from the repeater may be indirectly identified via alternatives 1 to 3. In alternatives 2 and 3, a case where repeater TEG information is included and provided is a case where the UE should consider an internal delay occurring in the repeater, and may be a case where a signal transmitted by the base station is transferred to the UE via the repeater. However, since it is difficult for the base station and the location server to identify an accurate value of an internal delay occurring in the repeater, a value of the internal delay may be assumed to be a specific value, so that the value may be provided in addition to TX TEG information in the case of alternative 2, and the value may be provided separately from the TX TEG information in the case of alternative 3.

When the information on propagation delay occurring in the base station 701 and the repeater 704 is provided also via assistance data, the following alternatives may be considered. However, the disclosure is not limited to the following alternatives.
Alternative 1: Whether the UE should consider a propagation delay (this may be provided only for UE-based positioning)
Alternative 2: Propagation delay information is provided in addition to TX TEG information (propagation delay information may be provided only for UE-based positioning)
Alternative 3: Propagation delay information is provided separately from TX TEG information (propagation delay information may be provided only for UE-based positioning)

The above alternatives may also be considered when both repeater TEG information and propagation delay information are provided via assistance data.

Subsequently, the location server 700 may request location information from the UE 703 via LPP in operation 724. Then, the UE 703 may provide the location information via LPP in operation 725. In operation 725, as a method for mitigating a timing error, the UE may perform location measurement using the repeater TEG information or TX TEG information described above. In addition, the location information provided by the UE 703 in operation 725 may include positioning measurement information based on the DL PRS 730 for the UE-assisted scheme. In the UE-assisted scheme, the location server 700 may calculate a coordinate location of the UE, based on the positioning measurement information provided by the UE 703. In contrast, for the UE-based scheme, the UE 703 may directly calculate a coordinate location and provide the coordinate location as the location information. In particular, for the UE-assisted scheme, the UE 703 may transmit not only the location information but also the RX TEG information of the UE 703 (which may be a value corresponding to 602 of FIG. 6) in operation 725. In an embodiment, a point in time at which TEG information is provided is described, but in the disclosure, a point in time at which TEG information is provided is not limited to a specific time point and operation.

In FIG. 7, the UE 703 is generally unable to identify whether the signal has been received by being forwarded via the repeater 704 or received directly from the base station 701 without going through the repeater 704. However, the UE 703 may indirectly (implicitly) identify, via the repeater TEG information, whether the signal has been received by being forwarded via the repeater 704 or received directly from the base station 701 without going through the repeater 704. In addition, the disclosure is not limited thereto. In other words, embodiments of the disclosure may include a case where, when a signal is received, the UE 703 may directly (explicitly) identify, based on additional information, whether the signal has been received by being forwarded via the repeater 704. In the disclosure, the method by which the UE identifies this information is not limited to a specific method. If the UE 703 is able to determine whether the received signal has been forwarded via the repeater 704, the UE 703 may determine whether to apply the repeater TEG information when performing positioning measurement. In other words, positioning measurement may be performed by applying repeater TEG only for a signal received by being forwarded via the repeater 704.

### Fifth Embodiment

The fifth embodiment describes a method of mitigating a timing error without explicitly exchanging information on delay error causes, such as a propagation delay and an internal delay occurred in a repeater, when a UL signal is received by the repeater, and a UL SRS for positioning is also forwarded during retransmission of the signal. Here, the fact that the information on delay error causes is not explicitly exchanged may be interpreted as the C-link 750 in FIG. 7 not being taken into account. However, it is noted that the base station and the repeater may exchange the information on delay error causes in an implementation-specific manner.

FIG. 7 is a diagram illustrating a positioning procedure considering a repeater in a Uu interface according to an embodiment of the disclosure.

Unlike in FIG. 3, a signal transmitted by the UE 703 may be forwarded to the base station 701 via the repeater 704. Therefore, an LPP message and a UL SRS for positioning may be forwarded via the repeater. In FIG. 7, the location server 700 may be able to identify approximate locations of the repeater 704 and the UE 703 in advance. This may be possible via a method such as E-CID. In the disclosure, the method by which the location server 700 is able to identify approximate locations of the repeater 704 and the UE 703 in advance is not limited to a specific method. If the location server 700 has identified approximate locations of the repeater 704 and the UE 703 in advance, when the location server 700 performs positioning to identify an accurate location (including coordinate information) of the UE 703, for example, when the UE 703 transmits a UL SRS to the base station 701, whether the signal will be transferred to the UE 703 via the repeater 704 may be predicted. In the fourth embodiment, the C-link 750 in FIG. 7 is not considered. Accordingly, unlike the second embodiment, an environment is considered in which it is difficult for the base station and the location server to control the repeater via information exchange with the repeater.

Referring to FIG. 7, the location server 700 may request UE capability from the UE 703 via LPP in operation 721. The UE 703 may provide supportable positioning information to the location server in operation 722. For example, the UE capability may include whether a positioning method supported by the UE 703 is UE-assisted or UE-based, or whether both thereof are possible.

Subsequently, the location server 700 and the base station 701 may exchange, via the LPPa or NRPPa 710, information required for positioning. For this, reference may be made to the information exchange function between the base station and the location server via LPPa or NRPPa. For example, the exchanged information may include the following information. However, the information exchanged between the base station 701 and the location server 700 via the LPPa or NRPPa 710 in the disclosure is not limited to the following. When the base station and the repeater are able to exchange information on delay error causes, such as a propagation delay and an internal delay occurred in the repeater, including repeater coordinate location information and repeater identification information, the information presented in the second embodiment may be exchanged between the base station and the location server via LPPa or NRPPa.
Base station RX TEG information (which may be a value corresponding to the gNB Rx internal timing delay 611 in FIG. 6.)
Information on propagation delay occurring in the base station 701 and the repeater 704 (corresponding to e_{delay_propagation1} in Equation 4):

Here, the information on propagation delay occurring in the base station 701 and the repeater 704 may be replaced with another term referring to the same. Alternatively, instead of the information on propagation delay, other terms referring to ToF information and information on the distance between the base station 701 and repeater 704 may be used as replacement. If the information is not included, the base station may have already applied a timing error value corresponding to the propagation delay at positioning measurement.

Subsequently, the location server 700 may transmit assistance data to the UE 703 via LPP in operation 723. For this, reference may be made to the functions of LPP. For example, the assistance data may include the following information. The information provided as the assistance data between the location server 700 and the UE 703 in the disclosure is not limited to the following.
UL SRS 740 configuration information

Subsequently, the location server 700 may request location information from the UE 703 via LPP in operation 724. Then, the UE 703 may transmit a UL SRS for positioning via LPP in operation 725. The UE may transmit TX TEG information of the UE 703 (which may be a value corresponding to the UE Tx internal timing delay 612 of FIG. 6) as well as the UL SRS in operation 725. Unlike the fourth embodiment, in the method of the fifth embodiment, the base station 701 may perform positioning measurement using the UL SRS, and the location server 700 may calculate a coordinate location of the UE based on the positioning measurement information that the base station 701 has provided to the location server 700. When the base station 701 performs positioning measurement using the UL SRS or when the location server 700 calculates the position of the UE 703, whether an internal delay occurring in the repeater 704 should be considered may be determined. However, since it is difficult for the base station and location server to precisely identify an accurate value of the internal delay occurring in the repeater, the value may be assumed to be a specific value. The internal delay occurring in the repeater 704 may be applied as a value of the repeater TEG. Since each UE has a different location, and the base station 701 may or may not receive a signal via the repeater 704, repeater TEG information may be information UE-dedicatedly (or UE-specifically) applied to the UE. In an embodiment, a point in time at which TEG information is provided is described, but in the disclosure, a point in time at which TEG information is provided is not limited to a specific time point and operation.

In FIG. 7, the base station 701 is generally unable to identify whether the signal has been received by being forwarded via the repeater 704 or received directly from the UE 703 without going through the repeater 704. However, the base station 701 may indirectly (implicitly) identify, via the repeater TEG information, whether the signal has been received by being forwarded via the repeater 704 or received directly from the UE 703 without going through the repeater 704. In addition, the disclosure is not limited thereto. In other words, embodiments of the disclosure may include a case where, when the base station 701 receives a signal, the base station 701 and the location server 700 may directly (explicitly) identify, based on additional information, whether the signal has been received by being forwarded via the repeater 704. In the disclosure, the method by which the base station and the location server identify corresponding information is not limited to a specific method. If the base station 701 and the location server 700 are able to determine whether the signal received by the base station has been forwarded via the repeater 704, the base station 701 and the location server 700 may determine whether to apply the repeater TEG information when performing positioning measurement. In other words, positioning measurement may be performed by applying repeater TEG only for a signal received by being forwarded via the repeater 704.

### Sixth Embodiment

The sixth embodiment proposes a method of mitigating a timing error without explicitly exchanging information on delay error causes, such as a propagation delay and an internal delay occurred in a repeater, when an SL signal is received by the repeater, and an SL PRS is also forwarded during retransmission of the signal. Here, the fact that the information on delay error causes is not explicitly exchanged may be interpreted as the C-link 750 in FIG. 7 not being taken into account. However, the base station and the repeater may exchange the information on delay error causes in an implementation-specific manner.

FIG. 8 is a diagram illustrating a positioning procedure considering a repeater in an SL according to an embodiment of the disclosure.

Unlike in FIG. 4, a signal transmitted by a UE may be forwarded to another UE via the repeater 804. Therefore, an SLPP message and an SL PRS for positioning may be forwarded via the repeater 804. In FIG. 8, the location server 800 may be able to identify approximate locations of the repeater 804 and the UE 803 in advance. This may be possible via a method similar to E-CID. In the embodiment, the C-link 750 in FIG. 8 is not considered. Accordingly, unlike the third embodiment, an environment is considered in which it is difficult for the base station and the location server to control the repeater via information exchange with the repeater.

In the disclosure, the method by which the location server 800 is able to identify approximate locations of the repeater 804 and the UE in advance is not limited to a specific method. If the location server 800 has identified approximate locations of the repeater 804 and the UE (UE-B) 803 in advance, when the location server 800 performs positioning to identify an accurate location (including coordinate information) of the UE (UE-B) 803, for example, when the UE (UE-A) 801 transmits an SL PRS to another UE (UE-B) 803, whether the signal will be transferred to the other UE (UE-B) 803 via the repeater 804 may be predicted. However, in SL, the location server 800 may not be considered if the UE is outside coverage of the base station. In this case, the other UE may perform functions similar to those of the location server 800.

Referring to FIG. 8, the location server 800 may request, in operation 821, UE capability via a sidelink positioning protocol (SLPP) from the UE 803 which performs positioning measurement and calculation. SLPP is a positioning protocol which enables execution of functions similar or identical to those of LPP, but is defined for positioning of a UE located outside base station coverage in SL, and may be referred to as a different name.

The UE 803 may provide supportable positioning information to the location server 800 in operation 822. If the UE 803 is within coverage of a base station, the location server 800 may be connected to the base station. Alternatively, if the UE is outside the base station coverage, the location server 800 may be connected to the UE. Alternatively, if the UE 803 is outside the base station coverage, the location server 800 may not be considered, and a UE (e.g., the UE (UE-A) 801) other than the UE (UE-B) 803 may provide functions similar to those of the location server 800. For example, the UE capability may include whether a positioning method supported by the UE is UE-assisted or UE-based, or whether both thereof are possible.

Subsequently, the location server 800 and the UE 801 may exchange information required for positioning via sidelink positioning protocol annex (SLPPa). SLPPa is a positioning protocol which enables execution of functions similar or identical to those of LPPa or NRPPa, but is defined for positioning of a UE located outside base station coverage in SL, and may be referred to as a different name. When the UE 801 and the repeater 804 are able to exchange information on delay error causes, such as a propagation delay and an internal delay occurred in the repeater, including repeater coordinate location information and repeater identification information, the information presented in the third embodiment may be exchanged between the UE 801 and the location server via SLPPa.

Subsequently, the location server 800 may transmit assistance data to the UE 803 via the SLPP in operation 823. For example, the assistance data may include the following information. The information provided as the assistance data between the location server 800 and the UE 803 in the disclosure is not limited to the following.
SL PRS 830 configuration information
Repeater TEG information (which may be provided only for UE-based positioning)
TX/RX TEG information of the UE 801 (which may be provided only for UE-based positioning)

The repeater TEG information refers to information on an internal delay occurring in the repeater. Since each UE has a different location, and some UEs transmit and receive signals via a repeater while others do not, repeater TEG information may be information UE-dedicatedly (or UE-specifically) applied to a UE. In addition, the following alternatives may be considered for the repeater TEG information provided via assistance data. However, the repeater TEG information in the disclosure is not limited to the following alternatives.
Alternative 1: Whether the UE should consider an internal delay occurring in the repeater (this may be provided only for UE-based positioning)
Alternative 2: Repeater TEG information is provided in addition to TX TEG information (repeater TEG information may be provided only for UE-based positioning)
Alternative 3: Repeater TEG information is provided separately from TX TEG information (repeater TEG information may be provided only for UE-based positioning)

For alternative 1, whether the UE should consider an internal delay occurring in the repeater may be indicated by 1-bit information. A case where the UE should consider an internal delay occurring in the repeater may be a case where a signal transmitted by the base station is transferred to the UE via the repeater. If it is indicated, in alternative 1, that an internal delay occurring in the repeater should be considered, the UE may de-prioritize a corresponding measurement result from a positioning measurement result candidate list. In other words, a positioning measurement result for a signal received without going through the repeater may be treated to have a higher priority than a positioning measurement result for a signal received through the repeater, and this may be reflected when reporting a measurement result to the location server. This may be interpreted as an operation in which the UE reports, as a more preferred (prioritized) measurement result, a signal result received without going through the repeater from the positioning measurement result candidate list. Whether a signal received by the UE is forwarded from the repeater may be indirectly identified via alternatives 1 to 3. In alternatives 2 and 3, a case where repeater TEG information is included and provided is a case where the UE should consider an internal delay occurring in the repeater, and may be a case where a signal transmitted by the base station is transferred to the UE via the repeater. However, since it is difficult for the base station and the location server to identify an accurate value of an internal delay occurring in the repeater, a value of the internal delay may be assumed to be a specific value, so that the value may be provided in addition to TX TEG information in the case of alternative 2, and the value may be provided separately from the TX TEG information in the case of alternative 3.

Subsequently, the location server 800 may request location information from the UE 803 via the SLPP in operation 824. Then, the UE 803 may provide the location information via the SLPP in operation 825. In operation 825, as a method for mitigating a timing error, the UE may perform location measurement using the repeater TEG information or TX TEG information described above. In addition, the location information provided by the UE 803 in operation 825 may be positioning measurement information based on the SL PRS 830 for the UE-assisted scheme. In the UE-assisted scheme, the location server 800 may calculate a coordinate location of the UE 803, based on the positioning measurement information provided by the UE 803. In contrast, for the UE-based scheme, the UE 803 may directly calculate a coordinate location and provide the coordinate location as the location information. In particular, for the UE-assisted scheme, the UE 803 may transmit not only the location information but also the TX/RX TEG information of the UE 803 in operation 825. In an embodiment, a point in time at which TEG information is provided is described, but in the disclosure, a point in time at which TEG information is provided is not limited to a specific time point and operation.

In FIG. 8, the UE 803 is generally unable to identify whether the signal has been received by being forwarded via the repeater 804 or received directly from the UE 801 without going through the repeater 804. However, the UE 803 may indirectly (implicitly) identify, via the repeater TEG information, whether the signal has been received by being forwarded via the repeater 804 or received directly from the UE 801 without going through the repeater 804. In addition, the disclosure is not limited thereto. In other words, embodiments of the disclosure may include a case where, when a signal is received, the UE 803 may directly (explicitly) identify, based on additional information, whether the signal has been received by being forwarded via the repeater 804. In the disclosure, the method by which the UE 803 identifies corresponding information is not limited to a specific method. If the UE 803 is able to determine whether the received signal has been forwarded via the repeater 804, the UE 803 may determine whether to apply the repeater TEG information when performing positioning measurement. In other words, positioning measurement may be performed by applying repeater TEG only for a signal received by being forwarded via the repeater 804.

### Seventh Embodiment

The seventh embodiment proposes a method in which a DL PRS is not forwarded during a procedure of receiving and retransmitting a DL signal by a repeater.

FIG. 7 is a diagram illustrating a positioning procedure considering a repeater in a Uu interface according to an embodiment of the disclosure.

However, a procedure 730-2 of forwarding a DL PRS by the repeater in FIG. 7 may not be performed. In other words, the repeater may not forward a DL PRS at a point in time when the DL PRS is received, but may forward signals received at other points in time. Accordingly, the UE 703 may expect no DL PRS to be forwarded by the repeater 704. In order for the repeater to forward no DL PRS and only forward other signals, the repeater needs to identify whether a received signal is a DL PRS. To this end, the repeater needs to decode the received signal. For example, in operation 723, the repeater may decode the LPP message to identify DL PRS configuration information, and identify a transmission occasion of the DL PRS. This may be information such as a DL PRS transmission periodicity. The DL PRS configuration information may be transferred via other messages between the base station and UE, not via the LPP message. Alternatively, if NCR is considered, the base station may provide information on the transmission occasion of the DL PRS to the repeater via the C-link 750. In this case, the repeater may have an advantage of not having to separately decode the received signal. However, if the repeater does not forward the DL PRS, the DL PRS transmitted by the base station may not reach the UE with wider coverage via the repeater.

A method performed by a repeater in a wireless communication system according to an embodiment of the disclosure may include: transmitting first control information to a base station, wherein the first control information includes location information of the repeater, identification information of the repeater, repeater TEG information for a delay occurring inside the repeater, and propagation delay information for a delay occurring while a downlink (DL) positioning reference signal (PRS) is being transmitted between the base station and the repeater; receiving, from the base station, second control information including information related to a transmission occasion at which the DL PRS is transmitted by the base station; receiving the DL PRS and assistance data from the base station, wherein the assistance data includes configuration information of the DL PRS and base station TEG information for a delay occurring inside the base station; and based on the transmission occasion at which the DL PRS is transmitted by the base station, transmitting the assistance data among the assistance data and the DL PRS to a UE. Location information of the UE may be based on the assistance data.

A method performed by a repeater in a wireless communication system according to an embodiment of the disclosure may include: transmitting control information to a base station, wherein the control information includes location information of the repeater, identification information of the repeater, repeater TEG information for a delay occurring inside the repeater, and propagation delay information for a delay occurring while a downlink (DL) positioning reference signal (PRS) is being transmitted between the base station and the repeater; and receiving the DL PRS and assistance data from the base station, wherein the assistance data includes configuration information of the DL PRS and base station TEG information for a delay occurring inside the base station, and the configuration information of the DL PRS includes information related to a transmission occasion at which the DL PRS is transmitted by the base station. The method performed by the repeater may include, based on the transmission occasion at which the DL PRS is transmitted by the base station, transmitting the assistance data among the assistance data and the DL PRS to a UE. Location information of the UE may be based on the assistance data.

### Eighth Embodiment

The eighth embodiment proposes a method in which a UL SRS for positioning is not forwarded during a procedure of receiving and retransmitting a UL signal by a repeater.

FIG. 7 is a diagram illustrating a positioning procedure considering a repeater in a Uu interface according to an embodiment of the disclosure.

However, a procedure 740-2 of forwarding a UL SRS by the repeater in FIG. 7 may not be performed. In other words, the repeater may not forward a UL SRS at a point in time when the UL SRS is received, but may forward signals received at other points in time. Accordingly, the base station 701 may expect no UL SRS to be forwarded by the repeater 704. In order for the repeater to forward no UL SRS and only forward other signals, the repeater needs to identify whether a received signal is a UL SRS. To this end, the repeater needs to decode the received signal. For example, in operation 723, the repeater may decode the LPP message to identify UL SRS configuration information, and identify a transmission occasion of the UL SRS. This may be information such as a UL SRS transmission periodicity. The UL SRS configuration information may be transferred via other messages between the base station and UE, not via the LPP message. Alternatively, if NCR is considered, the base station may provide information on the transmission occasion of the UL SRS to the repeater via the C-link 750. In this case, the repeater may have an advantage of not having to separately decode the received signal. However, if the repeater does not forward the UL SRS, the UL SRS transmitted by the UE may not reach the base station with wider coverage via the repeater.

### Ninth Embodiment

The ninth embodiment proposes a method in which an SL PRS is not forwarded during a procedure of receiving and retransmitting an SL signal by a repeater.

FIG. 8 is a diagram illustrating a positioning procedure considering a repeater in an SL according to an embodiment of the disclosure.

However, a procedure 830-2 of forwarding an SL PRS by the repeater in FIG. 8 may not be performed. In other words, the repeater may not forward an SL PRS at a point in time when the SL PRS is received, but may forward signals received at other points in time. Accordingly, the UE 803 may expect no SL PRS to be forwarded by the repeater 804. In order for the repeater to forward no SL PRS and only forward other signals, the repeater needs to identify whether a received signal is an SL PRS. To this end, the repeater needs to decode the received signal. For example, in operation 823, the repeater may decode the SLPP message to identify SL PRS configuration information, and identify a transmission occasion of the SL PRS. This may be information such as an SL PRS transmission periodicity. The SL PRS configuration information may be transferred via other messages between the UEs, not via the SLPP message. Alternatively, if NCR is considered, the base station may provide information on the transmission occasion of the SL PRS to the repeater via the C-link 805. In this case, the repeater may have an advantage of not having to separately decode the received signal. However, if the repeater does not forward the SL PRS, the SL PRS transmitted by the UE may not reach another UE with wider coverage via the repeater.

A method performed by a repeater in a wireless communication system according to an embodiment of the disclosure may include transmitting first control information to a first UE, wherein the first control information includes location information of the repeater, identification information of the repeater, repeater TEG information for a delay occurring inside the repeater, and propagation delay information for a delay occurring while a sidelink (SL) positioning reference signal (PRS) is being transmitted between the first UE and the repeater. The method may further include: receiving, from the first UE, second control information including information related to a transmission occasion at which the SL PRS is transmitted by the first UE; and receiving the SL PRS and assistance data from the first UE, wherein the assistance data includes configuration information of the SL PRS and first UE TEG information for a delay occurring inside the first UE. The method may further include, based on the transmission occasion at which the SL PRS is transmitted by the first UE, transmitting the assistance data among the assistance data and the SL PRS to a second UE. Location information of the second UE may be based on the assistance data.

A method performed by a repeater in a wireless communication system according to an embodiment of the disclosure may include transmitting control information to a first UE, wherein the control information includes location information of the repeater, identification information of the repeater, repeater TEG information for a delay occurring inside the repeater, and propagation delay information for a delay occurring while a sidelink (SL) positioning reference signal (PRS) is being transmitted between the first UE and the repeater. The method may further include receiving the SL PRS and assistance data from the first UE, wherein the assistance data includes configuration information of the SL PRS and first UE TEG information for a delay occurring inside the first UE, and the configuration information of the SL PRS includes information related to a transmission occasion at which the SL PRS is transmitted by the first UE. The method may include, based on the transmission occasion at which the SL PRS is transmitted by the base station, transmitting the assistance data among the assistance data and the SL PRS to a second UE. Location information of the second UE may be based on the assistance data.

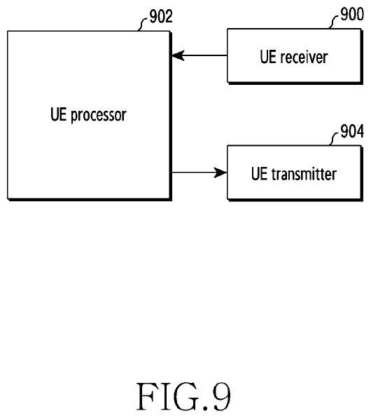

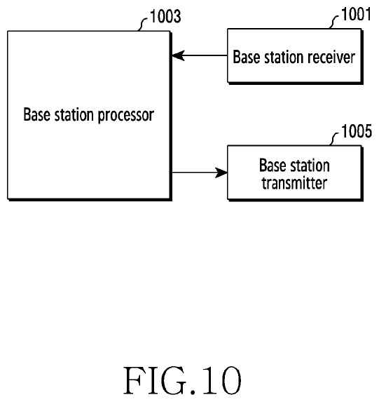

Transmitters, receivers, and processors of the UE and the base station for performing the above embodiments of the disclosure are illustrated in FIG. 9 and FIG. 10, respectively. The above embodiments provide methods for performing positioning by the UE, and each of the transmitters, receivers, and processors of the UE and the base station needs to be operated according to the embodiments in order to perform the methods.

FIG. 9 is a block diagram illustrating an internal structure of a UE according to an embodiment of the disclosure.

As illustrated in FIG. 9, the UE of the disclosure may include a UE receiver 900, a UE transmitter 904, and a UE processor 902. The UE receiver 900 and the UE transmitter 904 as a whole may be referred to as a transceiver. The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. In addition, the transceiver may receive signals through a radio channel, output the same to the UE processor 902, and transmit signals output from the UE processor 902 through the radio channel. The UE processor 902 may control a series of processes such that the UE can operate according to the above-described embodiments of the disclosure. In an embodiment, the UE processor 902 may include at least one processor.

FIG. 10 is a block diagram illustrating an internal structure of a base station according to an embodiment of the disclosure.

As illustrated in FIG. 10, the base station of the disclosure may include abase station receiver 1001, a base station transmitter 1005, and a base station processor 1003. The base station receiver 1001 and the base station transmitter 1005 as a whole may be referred to as a transceiver. The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. In addition, the transceiver may receive signals through a radio channel, output the same to the base station processor 1003, and transmit signals output from the base station processor 1003 through the radio channel. The base station processor 1003 may control a series of processes such that the base station can operate according to the above-described embodiments of the disclosure. In an embodiment, the base station processor 1003 may include at least one processor.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary.

The embodiments of the disclosure described and shown in the specification and the drawings are merely particular examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. As an example, all embodiment of the disclosure may be partially combined with each other to operate a base station and a terminal.

1. A method performed by a terminal in a wireless communication system, the method comprising:
receiving, from a location server by using a positioning protocol defined between the terminal and the location server, assistance data;
receiving, from a base station via a repeater, a downlink (DL) positioning reference signal (PRS);
receiving, from the location server, a request for a location of the terminal;
based on the DL PRS, acquiring a measurement value related to the location of the terminal; and
transmitting, to the location server, the measurement value or location information of the terminal,
wherein the location information is based on the assistance data and the measurement value, and
wherein the assistance data includes configuration information of the DL PRS, repeater timing error group (TEG) information for a delay occurring inside the repeater, base station TEG information for a delay occurring inside the base station, and propagation delay information for a delay occurring between the base station and the repeater.

2. The method of claim 1, wherein the acquiring of the measurement value comprises measuring a time taken for the DL PRS to be transmitted from the base station to the terminal.

3. The method of claim 1, further comprising, in case of transmitting the measurement value to the location server, transmitting, to the location server, terminal TEG information for a delay occurring inside the terminal.

4. The method of claim 1, further comprising, in case of transmitting the location information to the location server, acquiring the location information.

5. The method of claim 1, further comprising:
acquiring multiple measurement values for multiple DL PRSs; and
based on the repeater TEG information, identifying a DL PRS received by being forwarded via the repeater among the multiple DL PRSs,
wherein the transmitting of the measurement value or location information comprises transmitting the measurement value or location information by preferentially considering measurement values other than a measurement value for the DL PRS received by being forwarded via the repeater among the multiple measurement values.

6. The method of claim 1, further comprising:
receiving, from the location server, a request for terminal capability for a positioning scheme by using the positioning protocol; and
reporting, to the location server, the terminal capability for the positioning scheme by using the positioning protocol,
wherein the request for the location of the terminal includes, based on the terminal capability for the positioning scheme, a request for the measurement value or a request for the location information.

7. A terminal in a wireless communication system, the terminal comprising:
a transceiver; and
a controller connected to the transceiver,
wherein the controller is controlled to:
receive, from a location server by using a positioning protocol defined between the terminal and the location server, assistance data;
receive, from a base station via a repeater, a downlink (DL) positioning reference signal (PRS);
receive, from the location server, a request for a location of the terminal;
based on the DL PRS, acquire a measurement value related to the location of the terminal; and
transmit, to the location server, the measurement value or location information of the terminal,
wherein the location information is based on the assistance data and the measurement value, and
wherein the assistance data includes configuration information of the DL PRS, repeater timing error group (TEG) information for a delay occurring inside the repeater, base station TEG information for a delay occurring inside the base station, and propagation delay information for a delay occurring between the base station and the repeater.

8. The terminal of claim 7, wherein the controller is further configured to acquire the measurement value by measuring a time taken for the DL PRS to be transmitted from the base station to the terminal.

9. A method performed by a location server in a wireless communication system, the method comprising:
receiving, from a base station by using a positioning protocol annex defined between the base station and the location server, location information of a repeater, repeater TEG information for a delay occurring inside the repeater, repeater identification information, propagation delay information for a delay occurring while a downlink (DL) positioning reference signal (PRS) is transmitted between the base station and the repeater, and base station TEG information for a delay occurring inside the base station while the DL PRS is transmitted;
transmitting, to a terminal by using a positioning protocol defined between the terminal and the location server, assistance data including configuration information of the DL PRS, the repeater TEG information, the base station TEG information, and the propagation delay information;
transmitting, to the terminal by using the positioning protocol, a request for a location of the terminal; and
receiving, from the terminal by using the positioning protocol, a measurement value related to the location of the terminal or location information of the terminal,
wherein the measurement value is based on the DL PRS, and
wherein the location information is based on the assistance data and the measurement value.

10. The method of claim 9, wherein the measurement value is related to a time taken for the DL PRS to be transmitted from the base station to the terminal.

11. The method of claim 9, further comprising:
in case of receiving the measurement value from the terminal, receiving, from the terminal by using the positioning protocol, terminal TEG information for a delay occurring inside the terminal; and
based on the measurement value, the repeater TEG information, the base station TEG information, and the terminal TEG information, acquiring the location of the terminal.

12. The method of claim 9, wherein the repeater TEG information includes information indicating the terminal to consider the delay occurring inside the repeater at the time of acquiring the location information of the terminal,
wherein the repeater TEG information is used to identify a DL PRS forwarded via the repeater among multiple DL PRSs, and
wherein, as the measurement value or the location information, measurement values other than a measurement value for the DL PRS forwarded via the repeater are preferentially considered among multiple measurement values for the multiple DL PRSs.

13. The method of claim 9, further comprising:
requesting terminal capability for a positioning scheme to the terminal by using the positioning protocol; and
receiving the terminal capability for the positioning scheme from the terminal by using the positioning protocol,
wherein the request for the location of the terminal includes, based on the terminal capability for the positioning scheme, a request for the measurement value or a request for the location information.

14. A location server in a wireless communication system, the location server comprising:
a transceiver; and
a controller connected to the transceiver,
wherein the controller is controlled to:
receive, from a base station by using a positioning protocol annex defined between the base station and the location server, location information of a repeater, repeater TEG information for a delay occurring inside the repeater, repeater identification information, propagation delay information for a delay occurring while a downlink (DL) positioning reference signal (PRS) is transmitted between the base station and the repeater, and base station TEG information for a delay occurring inside the base station while the DL PRS is transmitted;
transmit assistance data including configuration information of the DL PRS, the repeater TEG information, the base station TEG information, and the propagation delay information to a terminal by using a positioning protocol defined between the terminal and the location server;
transmit, terminal to the terminal by using the positioning protocol, a request for a location of the; and
receive, from the terminal by using the positioning protocol, a measurement value related to the location of the terminal or location information of the terminal, wherein the measurement value is based on the DL PRS, and
wherein the location information is based on the assistance data and the measurement value.

15. The location server of claim 14, wherein the measurement value is related to a time taken for the DL PRS to be transmitted from the base station to the terminal.
